(19) United States
(12) Patent Application Publication
(10) Pub. No.: US 2006/0214557 A1
(43) Pub. Date: Sep. 28, 2006

(54) Light source

(75) Inventors: Iwao Ohwada, Nagoya-City (JP); Natsumi Shimogawa, Nagoya-City (JP); Tetsuyuki Kameji, Ama-Gun (JP); Naoki Goto, Ogaki-City (JP); Isao Shikata, Kasugai-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/377,520

(22) Filed: Mar. 16, 2006

Related U.S. Application Data
(60) Provisional application No. 60/665,166, filed on Mar. 25, 2005.

(51) Int. Cl. H01J 63/04; H01J 1/62; H01J 61/40

(52) U.S. Cl. 313/495; 313/497; 313/111

(57) ABSTRACT

A light source has a transparent substrate, a fixed substrate disposed in facing relation to the transparent substrate, and a plurality of electron emitters disposed on a principal surface of the fixed substrate. A light reflecting film is disposed on a portion of the principal surface of the fixed substrate which is free of the electron emitters. An anode electrode in the form of a transparent electrode is disposed on a substantially entire reverse side of the transparent substrate. Phosphor layers are disposed on the anode electrode at respective positions facing the electron emitters.

### BACKGROUND OF THE INVENTION

1. Field of the Invention

The present invention relates to a light source (including a planar light source) comprising electron emitters each for emitting electrons from an emitter by applying a drive voltage to electrodes on the emitter.

2. Description of the Related Art

Recently, electron emitters having a drive electrode and a common electrode have been finding use in various applications such as field emission displays (FEDs) and backlight units. In an FED, a plurality of electron emitters are arranged in a two-dimensional array, and a plurality of phosphor layers are positioned in association with the respective electron emitters with a predetermined gap left therebetween.

Conventional electron emitters are disclosed in Japanese Laid-Open Patent Publication No. 1-311533, Japanese Laid-Open Patent Publication No. 7-147131, Japanese Laid-Open Patent Publication No. 2000-285801, Japanese Patent Publication No. 46-20944, and Japanese Patent Publication No. 44-26125, for example. All of these disclosed electron emitters are disadvantageous in that since no dielectric body is employed in the emitter, a forming process or a micromachining process is required between facing electrodes, a high voltage needs to be applied to emit electrons, and a panel fabrication process is complex and entails a high panel fabrication cost.

It has been considered to make an emitter of a dielectric material. Various theories about the emission of electrons from a dielectric material have been presented in the documents: Yasuoka and Ishii, “Pulsed Electron Source Using a Ferroelectric Cathode”, OYO BUTURI (A monthly publication of The Japan Society of Applied Physics), Vol. 68, No. 5, p. 546-550 (1999), and Puchkarev, Victor F. and Mesyats, Gannady A., “On the Mechanism of Emission from the Ferroelectric Ceramic Cathode, Journal of Applied Physics, Vol. 78, No. 9, 1 Nov., 1995, p. 5633-5637.

The development of light sources employing carbon nanowalls has also been promoted lately (see, for example, Japanese Laid-Open Patent Publication No. 2004-362960 and Japanese Laid-Open Patent Publication No. 2004-362959).

### SUMMARY OF THE INVENTION

It is an object of the present invention to provide a light source comprising electron emitters for increasing the rate of utilization of phosphorescent light emission based on electrons emitted from the electron emitters to achieve high-luminance light emission.

A light source according to a first aspect of the present invention has at least one electron emitter, a transparent substrate for guiding therethrough a phosphorescent light emission based on electrons emitted from the electron emitter, and light reflecting means disposed in facing relation to the transparent substrate, for reflecting the phosphorescent light emission to the transparent substrate.

Since the phosphorescent light emission based on the electrons emitted from the electron emitter is reflected to the transparent substrate by the light reflecting means, the light reflected by the light reflecting means can be utilized as a surface emission, i.e., an emission from a front surface of the transparent substrate. Accordingly, the utilization ratio of the emitted phosphorescent light is increased for a high-luminance light emission.

In the first aspect, the light source may further comprise an anode electrode comprising a transparent electrode, and a phosphor layer, the anode electrode and the phosphor layer being disposed on a surface of the transparent substrate, the surface facing the light reflecting means. With this arrangement, the electrons emitted from the electron emitter are accelerated by the anode electrode and impinge upon the phosphor layer, which emits phosphorescent light.

In the first aspect, at least the phosphor layer may be disposed partly on the transparent substrate and provides an opening through which the transparent electrode is partly exposed. With this arrangement, the light reflected by the light reflecting means is not absorbed by the phosphor layer, but is emitted as a surface emission from the opening through the transparent substrate. Therefore, the utilization ratio of the emitted phosphorescent light is further increased.

In the first aspect, the anode electrode and the phosphor layer may be disposed partly on the transparent substrate and provide an opening through which the transparent substrate is partly exposed. With this arrangement, the light reflected by the light reflecting means is not absorbed or attenuated by the phosphor layer and the anode electrode, but is emitted as a surface emission from the opening through the transparent substrate. Therefore, the utilization ratio of the emitted phosphorescent light is further increased.

In the first aspect, the electron emitter may be disposed on a surface facing the transparent substrate and extending substantially parallel to a surface of the transparent substrate. With this arrangement, the electron emitter may be disposed on a fixed substrate disposed in facing relation to the transparent substrate.

In the first aspect, the electron emitter may be disposed on a surface extending not parallel to a surface of the transparent substrate. With this arrangement, the light source may further comprise a fixed substrate disposed in facing relation to the transparent substrate, and a side plate having the surface which extends substantially perpendicularly to at least the transparent substrate, the electron emitter being disposed on the surface of the side plate and facing a space defined between the transparent substrate and the fixed substrate.

In the first aspect, the light reflecting means may comprise a light reflecting layer and/or a white diffusion layer disposed on a portion of the fixed substrate, the portion being free of the electron emitter.

Alternatively, the fixed substrate may comprise a second transparent substrate such as a glass substrate, and the light reflecting means may comprise a light reflecting layer and/or a white diffusion layer disposed on a surface of the second transparent substrate remote from the transparent substrate.

In the first aspect, the light source may further comprise a fixed substrate disposed in facing relation to the transparent substrate, and an anode electrode and a phosphor layer which are disposed on a surface of the fixed substrate, the surface facing the transparent electrode. With this arrangement, the electron emitter may be disposed on a surface of the transparent substrate, the surface facing the fixed substrate.

With this arrangement, electrons emitted from the electron emitter are accelerated by the anode electrode on the fixed electrode, and impinge upon the phosphor layer, which is excited to emit phosphorescent light. Since the phosphorescent light is reflected to the transparent substrate by the light reflecting means, the reflected light is utilized as a surface emission from the transparent electrode.

In the above structure, a light diffusion member may be disposed on a surface of the transparent substrate remote from the fixed substrate, at a position aligned with the electron emitter. The light reflected from the light reflecting means is absorbed or attenuated by the electron emitter on the transparent substrate. However, ambient light is diffused by the light diffusion member and is utilized as a surface light emission, thus making up for the light absorbed or attenuated by the electron emitter thereby to suppress a reduction in the luminance which is caused by the electron emitter on the transparent substrate.

In the first aspect, the anode electrode may comprise a transparent electrode, the light reflecting means may comprise a light reflecting layer and/or a white diffusion layer disposed between the fixed substrate and the anode electrode. Alternatively, the anode electrode may double as the light reflecting means. For example, if the anode electrode has a mirror surface finish, it doubles as the light reflecting means.

Alternatively, the fixed substrate may comprise a second transparent substrate such as a glass substrate, and the light reflecting means may comprise a light reflecting layer and/or a white diffusion layer disposed on a surface of the second transparent substrate remote from the transparent substrate.

In the first aspect, the electron emitter may be disposed on a first surface extending at a first predetermined angle with respect to a surface of the transparent substrate, and the anode electrode may be disposed on a second surface extending at a second predetermined angle with respect to the surface of the transparent substrate. The phosphor layer may be disposed on the anode electrode in a position facing both the transparent substrate and the electron emitter.

With this arrangement, electrons emitted from the electron emitter on the first surface are accelerated by the anode electrode on the second surface, and impinge upon the phosphor layer, which is excited to emit phosphorescent light. Since the phosphorescent light is reflected to the transparent substrate by the light reflecting means, the reflected light is utilized as a surface emission from the transparent electrode.

In the above structure, a fixed substrate may be disposed in facing relation to the transparent substrate, and a support member may be disposed on the fixed substrate and provide the first surface and the second surface. The structure in which the electron emitter is disposed on the first surface and the anode electrode and the phosphor layer is disposed on the second surface can easily be realized.

The fixed substrate may comprise a second transparent substrate such as a glass substrate, and the light reflecting means may comprise a light reflecting layer and/or a white diffusion layer disposed on a surface of the second transparent substrate remote from the transparent substrate.

A light source according to a second aspect of the present invention has a transparent substrate, a fixed substrate disposed in facing relation to the transparent substrate, at least one electron emitter disposed on the fixed substrate, an anode electrode comprising a transparent electrode, a first phosphor layer, the anode electrode and the first phosphor layer being disposed on a surface of the transparent substrate, the surface facing the fixed substrate, and an auxiliary electrode and a second phosphor layer which are disposed on a portion of the fixed substrate, the portion being free of the electron emitter.

With this arrangement, electrons emitted from the electron emitter on the fixed substrate are accelerated by the anode electrode on the transparent substrate, and impinge upon the first phosphor layer on the transparent substrate, which is excited to emit phosphorescent light. The phosphorescent light is emitted as a surface emission. Electrons emitted from the electron emitter are also accelerated by the auxiliary electrode on the fixed substrate, and impinge upon the second phosphor layer on the fixed substrate, which is excited to emit phosphorescent light. The phosphorescent light is also emitted as a surface emission. Therefore, the surface emission as the phosphorescent light from the first phosphor layer on the transparent substrate and the surface emission as the phosphorescent light from the second phosphor layer on the fixed substrate are combined with each other and emitted from the light source. Accordingly, the utilization ratio of the emitted phosphorescent light is increased for a high-luminance light emission.

In the second aspect, the auxiliary electrode may function as light reflecting means for reflecting light emitted from the second phosphor layer to the transparent substrate. In this case, since the phosphorescent light emitted from the second phosphor layer to the fixed substrate is reflected by the auxiliary electrode and guided to the transparent substrate, the utilization ratio of the phosphorescent light is further increased.

In the second aspect, at least the first phosphor layer may be disposed partly on the transparent substrate and provides an opening through which the anode electrode is partly exposed, or the anode electrode and the first phosphor layer may be disposed partly on the transparent substrate and provide an opening through which the transparent substrate is partly exposed.

With this arrangement, the light reflected by the light reflecting means is not absorbed or attenuated by the first phosphor layer and the anode electrode, but is emitted as a surface emission from the opening of the first phosphor layer through the transparent substrate. Therefore, the utilization ratio of the emitted phosphorescent light is further increased.

A light source according to a third aspect of the present invention has at least one electron emitter, a transparent substrate for guiding therethrough a phosphorescent light emission based on electrons emitted from the electron emitter, and a laminated assembly disposed in facing relation to the transparent substrate, the laminated assembly comprising an anode electrode and a phosphor layer, the laminated assembly being oriented such that the phosphor layer confronts the transparent substrate.

With the above arrangement, electrons emitted from the electron emitter are accelerated by the anode electrode of the laminated assembly, and impinge upon the phosphor layer of the laminated assembly, which is excited to emit phosphorescent light. The emitted phosphorescent light is emitted as a surface emission, so that the utilization ratio of the emitted phosphorescent light is increased for a high-luminance light emission.

In the third aspect, the electron emitter may be disposed on a surface of the transparent substrate, the surface facing the laminated assembly, and the laminated assembly may have a bent portion in alignment with the electron emitter and ends fixed to the transparent substrate.

Alternatively, the electron emitter may be disposed on a surface not parallel to a surface of the transparent substrate, and the laminated assembly may have a bent portion in alignment with the electron emitter and at least one end fixed to the transparent substrate.

The light source according to the third aspect may further comprise a side plate having a surface which extends substantially perpendicularly to the transparent substrate, the electron emitter being disposed on a portion of the surface of the side plate, the portion facing the transparent substrate, the laminated assembly having an end fixed to the transparent substrate and other end fixed to the side plate.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a light source according to an embodiment of the present invention;

FIG. 2 is a schematic view of an electron emitter according to a first specific example;

FIG. 3A is a plan view of electrodes of an electron emitter;

FIG. 3B is a plan view of electrodes according to a first modification;

FIG. 4 is a plan view of electrodes according to a second modification;

FIG. 5 is a waveform diagram showing a drive voltage output from a drive circuit;

FIG. 6 is a fragmentary cross-sectional view illustrative of the manner in which a voltage Va1 is applied between an upper electrode and a lower electrode in the first specific example;

FIG. 7 is a fragmentary cross-sectional view illustrative of electron emission when a voltage Va2 is applied between the upper electrode and the lower electrode;

FIG. 8 is a fragmentary cross-sectional view illustrative of a self-inactivation of electron emission due to a negative charge on the surface of an emitter;

FIG. 9 is a characteristic diagram showing the relationship between the energy of emitted secondary electrons and the quantity of emitted secondary electrons;

FIG. 10A is a waveform diagram of a drive voltage;

FIG. 10B is a waveform diagram showing a change in the voltage between the upper electrode and the lower electrode of the electron emitter according to the first specific example;

FIG. 11 is a schematic view of electron emitters according to a second specific example;

FIG. 12 is an enlarged fragmentary cross-sectional view of an electron emitter according to a second specific example;

FIG. 13 is a plan view showing an example of the shape of through regions defined in an upper electrode;

FIG. 14A is a cross-sectional view of another example of the upper electrode;

FIG. 14B is an enlarged fragmentary cross-sectional view of the upper electrode;

FIG. 15A is a cross-sectional view of still another example of the upper electrode;

FIG. 15B is an enlarged fragmentary cross-sectional view of the upper electrode;

FIG. 16 is a diagram showing a voltage waveform of a drive voltage in a first electron emission process;

FIG. 17 is a view illustrative of emission of electrons in a second output period of the first electron emission process;

FIG. 18 is a diagram showing a voltage waveform of a drive voltage in a second electron emission process;

FIG. 19 is a view illustrative of emission of electrons in a second output period of the second electron emission process;

FIG. 20 is an equivalent circuit diagram showing a connected state of various capacitors connected between an upper electrode and a lower electrode;

FIG. 21 is a diagram illustrative of calculations of capacitances of the various capacitors connected between the upper electrode and the lower electrode;

FIG. 22 is a fragmentary plan view of a first modification of the electron emitter according to the second specific example;

FIG. 23 is a fragmentary plan view of a second modification of the electron emitter according to the second specific example;

FIG. 24 is a fragmentary plan view of a third modification of the electron emitter according to the second specific example;

FIG. 25 is a diagram showing the voltage vs. charge quantity characteristics (voltage vs. polarized quantity characteristics) of the electron emitter according to the second specific example;

FIG. 26A is a view illustrative of a state at a point p1 shown in FIG. 25;

FIG. 26B is a view illustrative of a state at a point p2 shown in FIG. 25;

FIG. 26C is a view illustrative of a state from the point p2 to a point p3 shown in FIG. 25;

FIG. 27A is a view illustrative of a state from the point p3 to a point p4 shown in FIG. 25;

FIG. 27B is a view illustrative of a state immediately prior to a point p4 shown in FIG. 25;

FIG. 27C is a view illustrative of a state from the point p4 to a point p6 shown in FIG. 25;

FIG. 28 is a fragmentary perspective view of a light source according to an embodiment of the present invention;

FIG. 29 is a perspective view of an array of electron emission units in the light source according to the embodiment of the present invention;

FIG. 30 is an enlarged fragmentary perspective view of an encircled portion Lc in FIG. 29;

FIG. 31 is an enlarged fragmentary perspective view of a first modification of the light source according to the embodiment of the present invention;

FIG. 32 is a view, partly in block form, of a second modification of the light source according to the embodiment of the present invention;

FIG. 33 is a view of a third modification of the light source according to the embodiment of the present invention;

FIG. 34 is a view, partly in block form, of a fourth modification of the light source according to the embodiment of the present invention;

FIG. 35 is a view, partly in block form, of a fifth modification of the light source according to the embodiment of the present invention;

FIG. 36 is a fragmentary cross-sectional view of a light source according to a first specific example;

FIG. 37 is a plan view of an array pattern of electron emitters and phosphor layers;

FIG. 38 is a plan view of another array pattern of electron emitters and phosphor layers;

FIG. 39 is a fragmentary cross-sectional view of a light source according to a second specific example;

FIG. 40 is a fragmentary cross-sectional view of a light source according to a third specific example;

FIG. 41 is a fragmentary cross-sectional view of a light source according to a fourth specific example;

FIG. 42 is a fragmentary cross-sectional view of a light source according to a fifth specific example;

FIG. 43 is a fragmentary cross-sectional view of a light source according to a sixth specific example;

FIG. 44 is a fragmentary cross-sectional view of a light source according to a seventh specific example;

FIG. 45 is a fragmentary cross-sectional view of a light source according to an eighth specific example;

FIG. 46 is a fragmentary cross-sectional view of a light source according to a ninth specific example;

FIG. 47 is a fragmentary cross-sectional view of a light source according to a tenth specific example;

FIG. 48 is a fragmentary cross-sectional view of a light source according to an eleventh specific example;

FIG. 49 is a fragmentary cross-sectional view of a light source according to a twelfth specific example;

FIG. 50 is a fragmentary cross-sectional view of a light source according to a thirteenth specific example;

FIG. 51 is a fragmentary cross-sectional view of a light source according to a fourteenth specific example;

FIG. 52 is a fragmentary cross-sectional view of a light source according to a fifteenth specific example;

FIG. 53 is a fragmentary cross-sectional view of a light source according to a sixteenth specific example;

FIG. 54 is a fragmentary cross-sectional view of a light source according to a seventeenth specific example;

FIG. 55 is a fragmentary cross-sectional view of a light source according to an eighteenth specific example;

FIG. 56 is a fragmentary cross-sectional view of a light source according to a nineteenth specific example;

FIG. 57 is a fragmentary cross-sectional view of a light source according to a twentieth specific example;

FIG. 58 is a fragmentary cross-sectional view of a light source according to a twenty-first specific example;

FIG. 59 is a fragmentary cross-sectional view of a light source according to a twenty-second specific example;

FIG. 60 is a fragmentary cross-sectional view of a light source according to a twenty-third specific example;

FIG. 61 is a fragmentary cross-sectional view of a light source according to a twenty-fourth specific example;

FIG. 62 is a fragmentary cross-sectional view of a light source according to a twenty-fifth specific example; and

FIG. 63 is a fragmentary cross-sectional view of a light source according to a twenty-sixth specific example.

### DESCRIPTION OF THE PREFERRED EMBODIMENTS

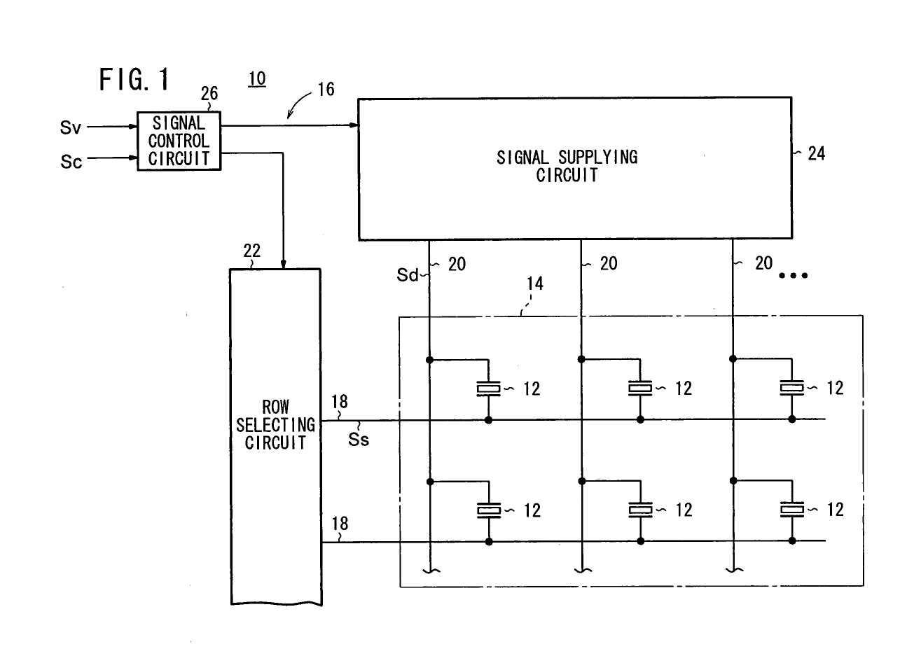

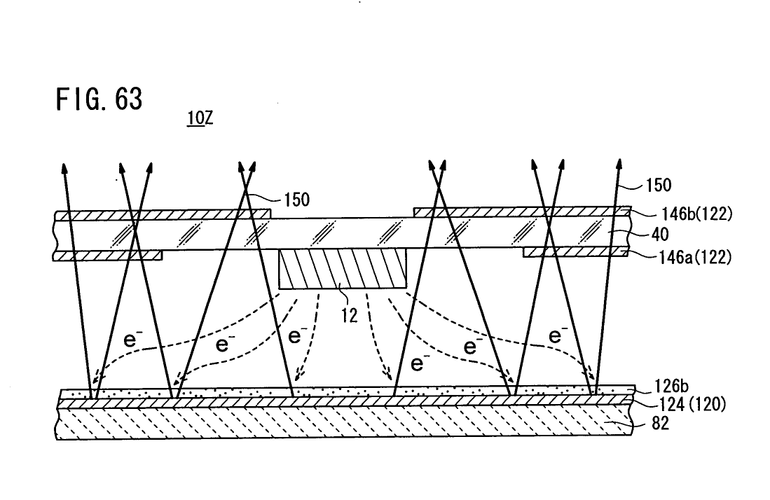

Light sources according to embodiments of the present invention will be described below with reference to FIGS. 1 through 63.

As shown in FIG. 1, a light source 10 according to an embodiment of the present invention is a light source in conformity with a display for displaying an image such as a liquid crystal display backlight or the like. As shown in FIG. 1, the light source 10 has a light emission section 14 comprising a matrix or staggered pattern of electron emitters 12 corresponding to respective light-emitting devices such as pixels, and a drive circuit 16 for driving the light emission section 14.

One electron emitter 12 may be assigned to each pixel, or a plurality of electron emitters 12 may be assigned to each pixel. In the present embodiment, it is assumed for the sake of brevity that one electron emitter 12 is assigned to each pixel.

The drive circuit 16 has a plurality of row selection lines 18 for selecting rows in the light emission section 14 and a plurality of signal lines 20 for supplying data signals Sd to the light emission section 14.

The drive circuit 16 also has a row selecting circuit 22 for supplying a selection signal Ss selectively to the row selection lines 18 to successively select a row of the electron emitters 12, a signal supplying circuit 24 for supplying parallel data signals Sd to the signal lines 20 to supply the data signals Sd to a row (selected row) selected by the row selecting circuit 22, and a signal control circuit 26 for controlling the row selecting circuit 22 and the signal supplying circuit 24 based on a control signal (video signal or the like) Sv and a synchronizing signal Sc that are input to the signal control circuit 26.

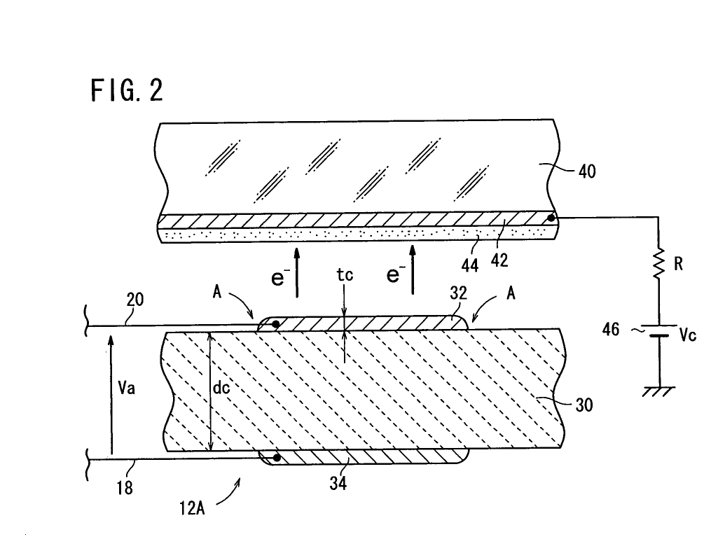

Two electron emitters, i.e., electron emitters 12A, 12B according to first and second specific examples, for use in the light source 10 according to the present embodiment will be described below with reference to FIGS. 2 through 27C.

As shown in FIG. 2, the electron emitter 12A according to the first specific example has a plate-like emitter 30, an upper electrode 32 disposed on a face side of the emitter 30, and a lower electrode 34 disposed on a reverse side of the emitter 30. Since the electron emitter 12A is of a structure in which the emitter 30 is sandwiched between the upper electrode 32 and the lower electrode 34, it provides a capacitive load. Therefore, the electron emitter 12A may be regarded as a capacitor.

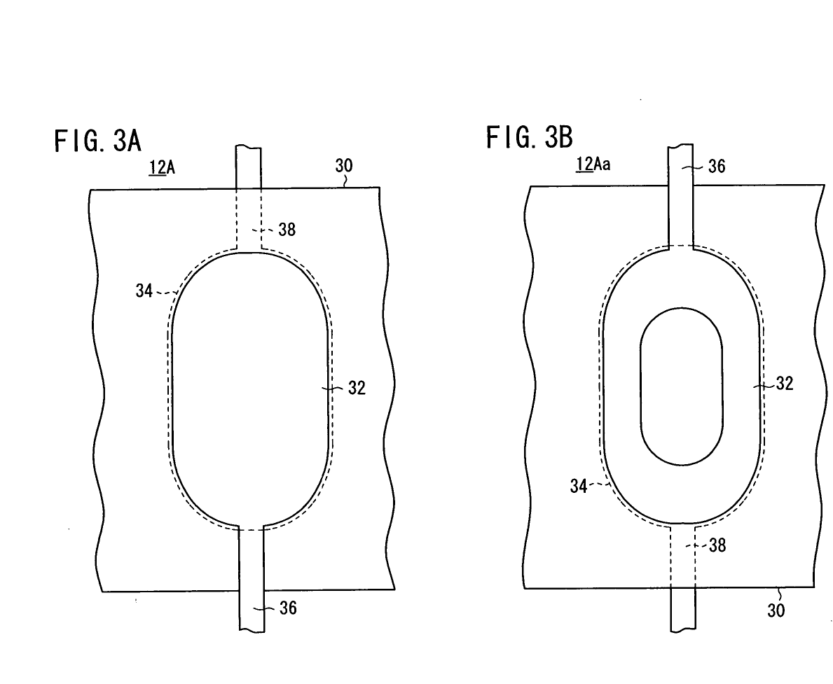

A drive voltage Va from the drive circuit 16 is applied between the upper electrode 32 and the lower electrode 34. Specifically, as shown in FIG. 3A, the drive voltage Va is applied between the upper electrode 32 and the lower electrode 34 through a lead electrode 36 extending to the upper electrode 32 and a lead electrode 38 extending to the lower electrode 34.

As shown in FIG. 2, if the electron emitter 12A is used in a light source 10, then a transparent substrate 40 of glass or acrylic resin is placed over the upper electrodes 32, and an anode electrode 42 comprising a transparent electrode, for example, is mounted on the reverse side of the transparent substrate 40, i.e., the surface of the transparent substrate 40 which faces the upper electrodes 32. The anode electrode 42 is coated with a phosphor 44. A bias power supply 46 having a bias voltage Vc is connected to the anode electrode 42 through a resistor R.

The electron emitter 12A is placed in a vacuum. As shown in FIG. 2, electric field concentration points A are present in the electron emitter 12A. Each of the electric field concentration points A may be defined as a point including a triple point where the upper electrode 32, the emitter 30, and the vacuum exist.

The vacuum level in the atmosphere should preferably be in the range from 10⁻² to 10⁻⁶ Pa and more preferably in the range from 10⁻³ to 10⁻⁵ Pa.

The reason for the above range is that in a lower vacuum, (1) many gas molecules would be present in the space, and a plasma can easily be generated and, if too an intensive plasma were generated, many positive ions thereof would impinge upon the upper electrode 32 and damage the same, and (2) emitted electrons would tend to impinge upon gas molecules prior to arrival at the anode electrode 42, failing to sufficiently excite the phosphor 44 with electrons that are sufficiently accelerated under the bias voltage Vc.

In a higher vacuum, though electrons would be liable to be emitted from an electric field concentration point A, structural body supports and vacuum seals would be large in size, posing disadvantages on efforts to make the electron emitter smaller in size.

The emitter 30 is made of a dielectric material. The dielectric material may preferably be a dielectric material having a relatively high dielectric constant, e.g., a dielectric constant of 1000 or higher. Dielectric materials of such a nature may be ceramics including barium titanate, lead zirconate, lead magnesium niobate, lead nickel niobate, lead zinc niobate, lead manganese niobate, lead magnesium tantalate, lead nickel tantalate, lead antimony stannate, lead titanate, lead magnesium tungstate, lead cobalt niobate, etc. or a combination of any of these materials, a material which chiefly contains 50 weight % or more of any of these materials, or such ceramics to which there is added an oxide of such as lanthanum, calcium, strontium, molybdenum, tungsten, barium, niobium, zinc, nickel, manganese, or the like, or a combination of these materials, or any of other compounds.

For example, a two-component material nPMN-mPT (n, m represent molar ratios) of lead magnesium niobate (PMN) and lead titanate (PT) has its Curie point lowered for a larger specific dielectric constant at room temperature if the molar ratio of PMN is increased.

Particularly, a dielectric material where n=0.85-1.0 and m=1.0-n is preferable because its specific dielectric constant is 3000 or higher. For example, a dielectric material where n=0.91 and m=0.09 has a specific dielectric constant of 15000 at room temperature, and a dielectric material where n=0.95 and m=0.05 has a specific dielectric constant of 20000 at room temperature.

For increasing the specific dielectric constant of a three-component dielectric material of lead magnesium niobate (PMN), lead titanate (PT), and lead zirconate (PZ), it is preferable to achieve a composition close to a morphotropic phase boundary (MPB) between a tetragonal system and a quasi-cubic system or a tetragonal system and a rhombohedral system, as well as to increase the molar ratio of PMN. For example, a dielectric material where PMN:PT:PZ=0.375:0.375:0.25 has a specific dielectric constant of 5500, and a dielectric material where PMN:PT:PZ=0.5:0.375:0.125 has a specific dielectric constant of 4500, which is particularly preferable. Furthermore, it is preferable to increase the dielectric constant by introducing a metal such as platinum into these dielectric materials within a range to keep them insulative. For example, a dielectric material may be mixed with 20 weight % of platinum.

The emitter 30 may be in the form of a piezoelectric/electrostrictive layer or an anti-ferroelectric layer. If the emitter 30 comprises a piezoelectric/electrostrictive layer, then it may be made of ceramics such as lead zirconate, lead magnesium niobate, lead nickel niobate, lead zinc niobate, lead manganese niobate, lead magnesium tantalate, lead nickel tantalate, lead antimony stannate, lead titanate, barium titanate, lead magnesium tungstate, lead cobalt niobate, or the like. or a combination of any of these materials.

The emitter 30 may be made of chief components including 50 wt % or more of any of the above compounds. Of the above ceramics, the ceramics including lead zirconate is mostly frequently used as a constituent of the piezoelectric/electrostrictive layer of the emitter 30.

If the piezoelectric/electrostrictive layer is made of ceramics, then lanthanum, calcium, strontium, molybdenum, tungsten, barium, niobium, zinc, nickel, manganese, or the like, or a combination of these materials, or any of other compounds may be added to the ceramics. Alternatively, ceramics produced by adding SiO₂, CeO₂, Pb₅Ge₃O₁₁, or a combination of any of these compounds to the above ceramics may be used. Specifically, a material produced by adding 0.2 wt % of SiO₂, 0.1 wt % of CeO₂, or 1 to 2 wt % of Pb₅Ge₃O₁₁ to a PT-PZ-PMN piezoelectric material is preferable.

For example, the piezoelectric/electrostrictive layer should preferably be made of ceramics including as chief components lead magnesium niobate, lead zirconate, and lead titanate, and also including lanthanum and strontium.

The piezoelectric/electrostrictive layer may be dense or porous. If the piezoelectric/electrostrictive layer is porous, then it should preferably have a porosity of 40% or less.

If the emitter 30 is in the form of an anti-ferroelectric layer, then the anti-ferroelectric layer may be made of lead zirconate as a chief component, lead zirconate and lead tin as chief components, lead zirconate with lanthanum oxide added thereto, or lead zirconate and lead tin as components with lead zirconate or lead niobate added thereto.

The anti-ferroelectric layer may be porous. If the anti-ferroelectric layer is porous, then it should preferably have a porosity of 30% or less.

If the emitter 30 is made of strontium tantalate bismuthate (SrBi₂Ta₂O₉), then its polarization inversion fatigue is small. Materials whose polarization inversion fatigue is small are laminar ferroelectric compounds and expressed by the general formula of (BiO₂)^{2′} (Aₘ₋₁BₘO₃ₘ₊₁)²⁻. Ions of the metal A are Ca²⁺, Sr²⁺, Ba²⁺, Pb²⁺, Bi³⁺, La³⁺, etc., and ions of the metal B are Ti⁴⁺, Ta⁵⁺, Nb⁵⁺, etc. An additive may be added to piezoelectric ceramics of barium titanate, lead zirconate, and PZT to convert them into a semiconductor. In this case, it is possible to provide an irregular electric field distribution in the emitter 30 to concentrate an electric field in the vicinity of the interface with the upper electrode 32 which contributes to the emission of electrons.

The sintering temperature can be lowered by adding glass such as lead borosilicate glass or the like or other compounds of low melting point (e.g., bismuth oxide or the like) to the piezoelectric/electrostrictive/anti-ferroelectric ceramics.

If the emitter 30 is made of piezoelectric/electrostrictive/anti-ferroelectric ceramics, then it may be a sheet-like molded body, a sheet-like laminated body, or either one of such bodies stacked or bonded to another support substrate.

If the emitter 30 is made of a non-lead-based material, then it may be a material having a high melting point or a high evaporation temperature so as to be less liable to be damaged by the impingement of electrons or ions.

The emitter 30 may be made by any of various thick-film forming processes including screen printing, dipping, coating, electrophoresis, aerosol deposition, powder jet deposition (film growth based on high-speed ejection of fine particles under the atmospheric pressure), etc., or any of various thin-film forming processes including an ion beam process, sputtering, vacuum evaporation, ion plating, chemical vapor deposition (CVD), plating, etc. Particularly, it is preferable to form a powdery piezoelectric/electrostrictive material as the emitter 30 and impregnate the emitter 30 thus formed with glass of a low melting point or sol particles. According to this process, it is possible to form a film at a low temperature of 700° C. or lower or 600° C. or lower.

The magnitude of the thickness dc (see FIG. 2) of the emitter 30 between the upper electrode 32 and the lower electrode 34 will be described below. If the voltage between the upper electrode 32 and the lower electrode 34, i.e., the voltage that appears between the upper electrode 32 and the lower electrode 34 when the drive voltage Va output from the drive circuit 16 is applied between the upper electrode 32 and the lower electrode 34, is represented by Vak, then the thickness dc should preferably be set in order to invert or change polarization in an electric field E expressed by E=Vak/dc. That is, as the thickness dc is smaller, the polarization can be reversed or changed at a lower voltage, enabling the electron emitter 12A to emit electrons when driven by a lower voltage, e.g., less than 100 V.

The upper electrode 32 should preferably be made of a conductor having a small sputtering yield and a high evaporation temperature in vacuum. For example, materials having a sputtering yield of 2.0 or less at 600 V in Ar⁺ and an evaporation pressure of 1.3×10⁻³ Pa at a temperature of 1800 K or higher are preferable. Such materials include platinum, molybdenum, tungsten, etc. The upper electrode 32 may be made of a conductor which is resistant to a high-temperature oxidizing atmosphere, e.g., a metal, an alloy, a mixture of insulative ceramics and a metal, or a mixture of insulative ceramics and an alloy. Preferably, the upper electrode 32 should be chiefly composed of a precious metal having a high melting point, e.g., platinum, iridium, palladium, rhodium, molybdenum, or the like, or an alloy of silver and palladium, silver and platinum, platinum and palladium, or the like, or a cermet of platinum and ceramics. Further preferably, the upper electrode 32 should be made of platinum only or a material chiefly composed of a platinum-base alloy. The upper electrode 32 should preferably be made of carbon or a graphite-base material, e.g., diamond thin film, diamond-like carbon, or carbon nanotube. Ceramics to be added to the electrode material should preferably have a proportion ranging from 5 to 30 volume %.

Furthermore, the upper electrode 32 should preferably be made of an organic metal paste which can produce a thin film after being baked. For example, a platinum resinate paste or the like, should preferably be used. An oxide electrode for suppressing a polarization inversion fatigue, which is made of ruthenium oxide, iridium oxide, strontium ruthenate, La₁₋ₓSrₓCoO₃ (e.g., x=0.3 or 0.5), La₁₋ₓCaₓMnO₃, La₁₋ₓCaₓMn_{1-y}Co_{y}O₃ (e.g., x=0.2, y=0.05), or a mixture of any one of these compounds and a platinum resinate paste, for example, is preferable.

The upper electrode 32 may be made of any of the above materials by any of thick-film forming processes including screen printing, spray coating, coating, dipping, electrophoresis, etc., or any of various thin-film forming processes including sputtering, an ion beam process, vacuum evaporation, ion plating, chemical vapor deposition (CVD), plating, etc. Preferably, the upper electrode 32 is made by any of the above thick-film forming processes.

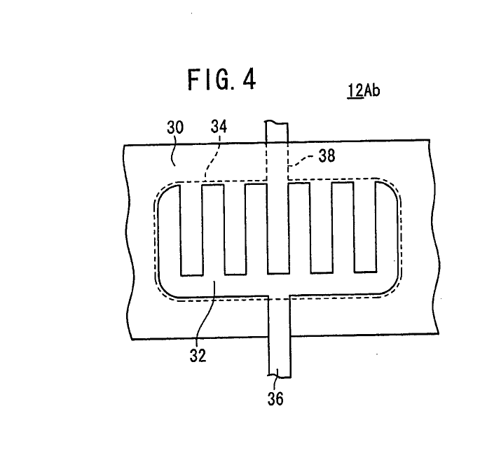

The plan surface of the upper electrode 32 may be an elliptical shape as shown in FIG. 3A, or a ring shape as with an electron emitter 12Aa according to a first modification shown in FIG. 3B. Alternatively, the plan surface of the upper electrode 32 may have a comb-toothed shape as with an electron emitter 12Ab according to a second modification shown in FIG. 4.

The ring-shaped or comb-toothed upper electrode 32 is effective to increase the number of triple points of the upper electrode 32, the emitter 30, and the vacuum as electric field concentration points A for increased electron emission efficiency.

The upper electrode 32 should preferably have a thickness tc (see FIG. 2) of 20 μm or less or preferably of 5 μm or less. Therefore, the thickness tc of the upper electrode 32 may be 100 nm or less. If the thickness tc of the upper electrode 32 is extremely small (10 nm or less), then electrons are emitted from the interface between the upper electrode 32 and the emitter 30 for further increased electron emission efficiency.

The lower electrode 34 is made of the same material according to the same process as the upper electrode 32. Preferably, the lower electrode 34 is made according to one of the above thick-film forming processes. The lower electrode 34 should preferably have a thickness of 20 μm or less or preferably of 5 μm or less.

Each time the emitter 30, the upper electrode 32, or the lower electrode 34 is formed, the assembly is heated (sintered) into an integral structure. Depending on how the upper electrode 32 and the lower electrode 34 are formed, however, the heating (sintering) process for producing an integral structure may not be required.

The sintering process for integrally combining the emitter 30, the upper electrode 32, and the lower electrode 34 may be carried out at a temperature ranging from 500 to 1400° C., preferably from 1000 to 1400° C. For heating the emitter 30 which is in the form of a film, the emitter 30 should preferably be sintered together with its evaporation source while their atmosphere is being controlled so that the composition of the emitter 30 will not become unstable at high temperatures.

The emitter 30 may be covered with a suitable member, and then sintered such that the surface of the emitter 30 will not be exposed directly to the sintering atmosphere.

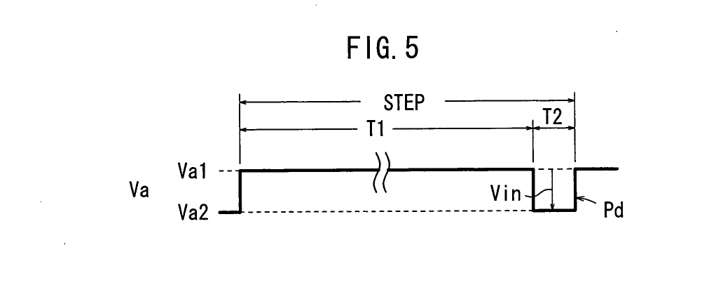

The principles of electron emission of the electron emitter 12A will be described below with reference to FIGS. 2, 5 through 10B. First, as shown in FIG. 5, a drive voltage Va output from the drive circuit 16 has repeated steps each including a period T1 in which a voltage Va1 making the potential of the upper electrode 32 higher than the potential of the lower electrode 34 is output and a period T2 in which a voltage Va2 making the potential of the upper electrode 32 lower than the potential of the lower electrode 34 is output. The voltage Va2 which is output in the period T2 is referred to as a drive pulse Pd.

The drive pulse Pd has an amplitude Vin that is defined as a value by subtracting the voltage Va2 from the voltage Va1 (=Va1−Va2).

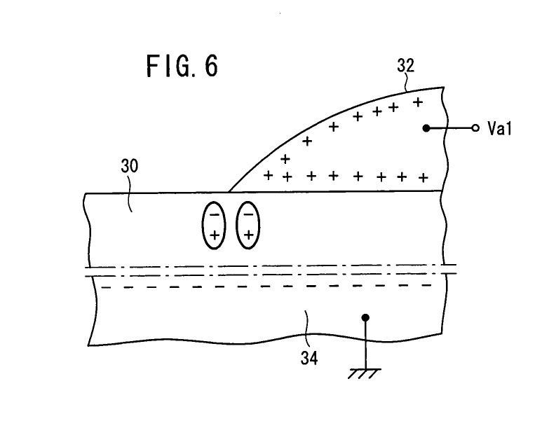

The period T1 is a period in which the voltage Va1 is applied between the upper electrode 32 and the lower electrode 34 to polarize the emitter 30, as shown in FIG. 6. The voltage Va1 may be a DC voltage, as shown in FIG. 5, but may be a single pulse voltage or a succession of pulse voltages. The period T1 should preferably be longer than the period T2 for sufficient polarization. For example, the period T1 should preferably be of 100 μsec. or longer. This is because the absolute value of the voltage Va1 for polarization is set so as to be smaller than the absolute value of the voltage Va2 for the purpose of lowering the power consumption at the time the voltage Va1 is applied and preventing damage to the upper electrode 32.

The voltages Va1, Va2 should preferably be of such voltage levels as to be able to polarize the emitter 30 reliably into positive and negative poles. For example, if the dielectric material of the emitter 30 has a coercive voltage, then the absolute values of the voltages Va1, Va2 should preferably be equal to or higher than the coercive voltage.

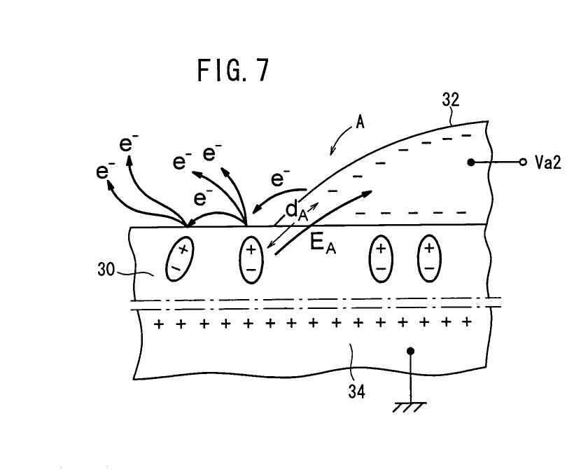

When the drive pulse Pd having an amplitude of a predetermined level is applied between the upper electrode 32 and the lower electrode 34, the polarization is inverted or changed in at least a portion of the emitter 30, as shown in FIG. 7. The portion of the emitter 30 where the polarization is inverted or changed includes a portion directly below the upper electrode 32 and a portion whose surface is exposed in the vicinity of the upper electrode 32, because the polarization seeps in the portion of the emitter 30 whose surface is exposed in the vicinity of the upper electrode 32. When the polarization is inverted or changed, a local electric field concentration occurs at the upper electrode 32 and the positive poles of the dipole moments near the upper electrode 32, drawing primary electrons from the upper electrode 32. The primary electrons from the upper electrode 32 impinge upon the emitter 30, causing the emitter 30 to emit secondary electrons.

If the electron emitter 12A has a triple point A of the upper electrode 32, the emitter 30, and the vacuum in the present embodiment, primary electrons are drawn from the portion of the upper electrode 32 near the triple point A, and the primary electrons drawn from the triple point A impinge upon the emitter 30, which emits secondary electrons. If the thickness of the upper electrode 32 is very small (up to 10 nm), then electrons are emitted from the interface between the upper electrode 32 and the emitter 30.

Operation of the electron emitter 12A at the time a drive pulse Pd having an amplitude of a predetermined level is applied will be described in greater detail below.

When a drive pulse Pd having an amplitude of a predetermined level is applied between the upper electrode 32 and the lower electrode 34, secondary electrons are emitted from the emitter 30, as described above. That is, in the emitter 30 whose polarization is inverted or changed, dipole moments which are charged in the emitter 30 in the vicinity of the upper electrode 32 draw emitted electrons.

Specifically, a local cathode is formed in the vicinity of the interface between the upper electrode 32 and the emitter 30, and the positive poles of dipole moments which are charged in the emitter 30 in the vicinity of the upper electrode 32 provide a local anode for drawing electrons from the upper electrode 32. Of the drawn electrons, some are guided to the anode electrode 42 (see FIG. 2) and excite the phosphor 44 to produce phosphorescent light. Of the drawn electrons, others impinge upon the emitter 30, which emit secondary electrons that are attracted to the anode electrode 42 and excite the phosphor 44.

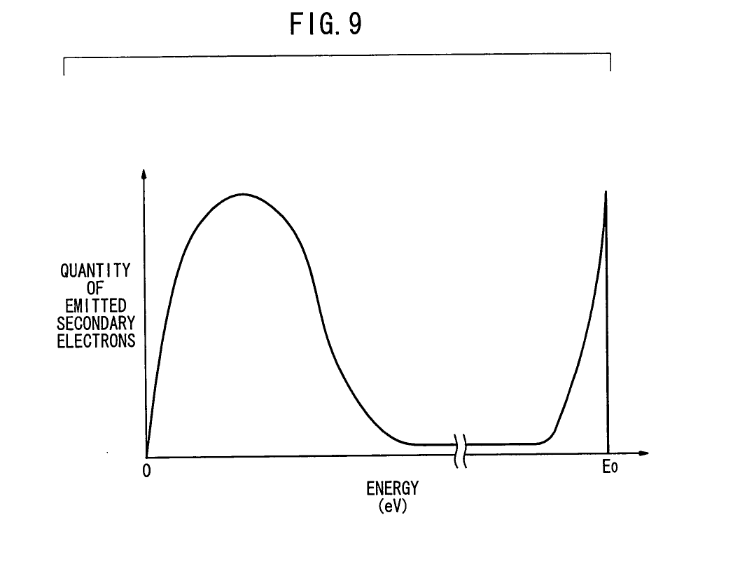

A distribution of the emitted secondary electrons will be described below with reference to FIG. 9. As shown in FIG. 9, most of the secondary electrons have an energy level which is nearly zero. When the secondary electrons are emitted from the surface of the emitter 30 into the vacuum, they only move according to an ambient electric field distribution. Specifically, the secondary electrons are accelerated from an initial velocity of almost 0 (m/sec.) according to the ambient electric field distribution. Therefore, as shown in FIG. 2, if there is an electric field Ea produced between the emitter 30 and the anode electrode 42, then the secondary electrons are emitted along a trajectory determined along the electric field Ea. That is, an electron source which emits electrons straightly is realized. The secondary electrons with the low initial speed are electrons in solid state that have jumped out of the emitter 30 under the energy produced by the coulomb collision with primary electrons.

As can be seen from FIG. 9, secondary electrons having an energy level corresponding to the energy E₀ of primary electrons are emitted. These secondary electrons are primary electrons emitted from the upper electrode 32 and scattered in the vicinity of the surface of the emitter 30 (reflected electrons). The secondary electrons referred to in the present specification are defined as including such reflected electrons and Auger electrons.

If the thickness of the upper electrode 32 is very small (up to 10 nm), then primary electrons emitted from the upper electrode 32 are reflected by the interface between the upper electrode 32 and the emitter 30 and directed toward the anode electrode 42.

As shown in FIG. 7, the intensity E_{A} of the electric field at the electric field concentration point A is expressed by E_{A}=V(1a, 1k)/d_{A} where V(1a, 1k) represents the potential difference between a local anode and a local cathode, and d_{A} represents the distance between a local anode and a local cathode. Since the distance d_{A} between a local anode and a local cathode is very small, the intensity E_{A} of the electric field which is required to emit electrons can easily be achieved. (In FIG. 7, an increase in the intensity E_{A} of the electric field is indicated by the solid-line arrow). This leads to a reduction in a voltage Vak.

As the emission of electrons from the upper electrode 32 proceeds, constituent atoms of the emitter 30 produced and floating when part of the emitter 30 is evaporated by the Joule heat are ionized into positive ions and electrons by the emitted electrons, and the electrons produced by the ionization further ionize constituent atoms of the emitter 30. Therefore, the number of electrons is exponentially increased to generated a local plasma in which the electrons and positive ions are neutral. Secondary electrons are also considered as promoting the ionization. The positive ions produced by the ionization may impinge upon the upper electrode 32, thus damaging the upper electrode 32.

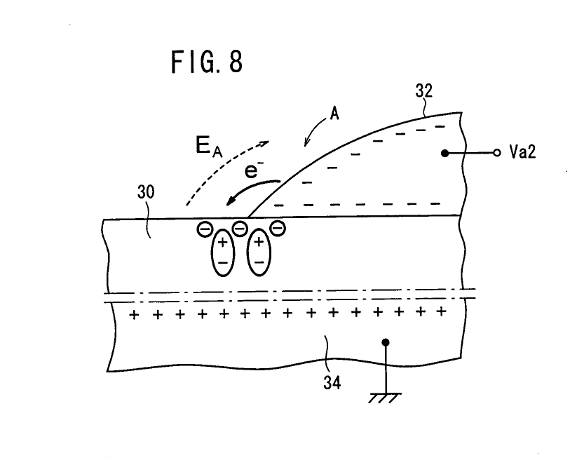

As shown in FIG. 8, however, in the electron emitter 12A, electrons drawn from the upper electrode 32 are attracted to the positive poles of dipole moments of the emitter 30 as the local anode, negatively charging the surface of the emitter 30 in the vicinity of the upper electrode 32. As a result, the factor for accelerating electrons (local potential difference) is reduced, and a potential for emitting secondary electrons is eliminated, allowing the surface of the emitter 30 to be further negatively charged.

Therefore, the positive polarity of the local anode provided by the dipole moments is reduced, and the intensity E_{A} of the electric field between a local anode and a local cathode is reduced. (In FIG. 8, a reduction in the intensity E_{A} of the electric field is indicated by the broken-line arrow). The reduction in the intensity E_{A} Of the electric field stops the emission of electrons.

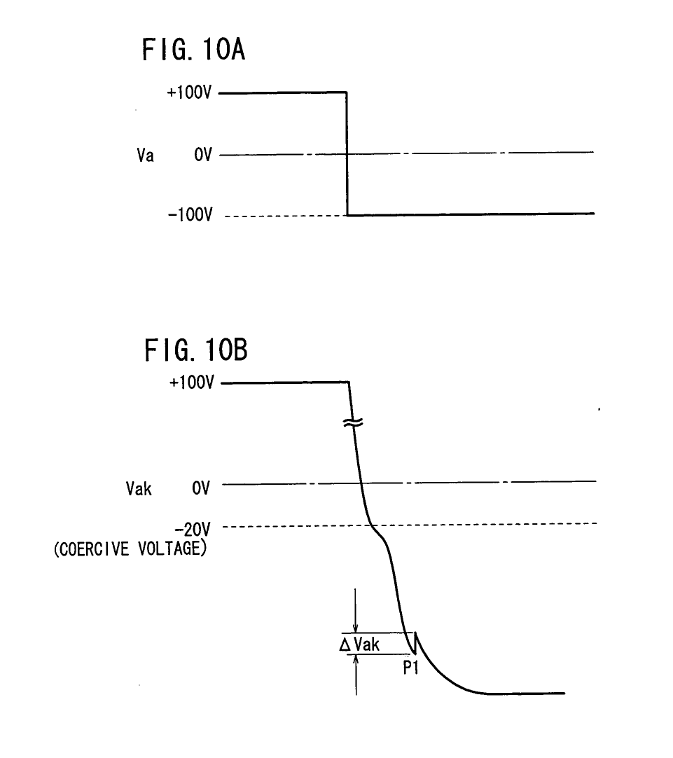

Specifically, as shown in FIG. 10A, when the drive voltage Va is applied between the upper electrode 32 and the lower electrode 34 such that the voltage Va1 is +100 V and the voltage Va2 is −100 V, for example, a voltage change ΔVak that occurs between the upper electrode 32 and the lower electrode 34 at a peak time point P1 when electrons are emitted is within 20 V (about 10 V in FIG. 10B), and hence the voltage Va is substantially unchanged. Therefore, almost no positive ions are produced, and the upper electrode 32 is prevented from being damaged by positive ions, resulting in a longer service life of the electron emitter 12A.

The dielectric breakdown voltage of the emitter 30 should preferably be at least 10 kV/mm. In the present embodiment, if the thickness dc of the emitter 30 is 20 μm, for example, the emitter 30 will not suffer dielectric breakdown even when a drive voltage of −100 V is applied between the upper electrode 32 and the lower electrode 34.

When electrons emitted from the emitter 30 impinge again upon the emitter 30 or atoms are ionized in the vicinity of the surface of the emitter 30, the emitter 30 may possibly be damaged or crystalline defects may be induced, thereby making the structure of the emitter 30 weak.

The emitter 30 should preferably be made of a dielectric material having a high evaporation temperature in vacuum, e.g., BaTiO₃ or the like containing no Pb. The atoms of the emitter 30 thus formed are less likely to evaporate due to the Joule heat, and are prevented from being ionized by electrons. This approach is effective in protecting the surface of the emitter 30.

The pattern shape and potential of the anode electrode 42 may appropriately be changed and control electrodes or the like may be disposed between the emitter 30 and the anode electrode 42 to establish a desired electric field distribution between the emitter 30 and the anode electrode 42, thereby controlling the trajectory of emitted secondary electrons and converging, enlarging, and modifying the electron beam diameter with ease.

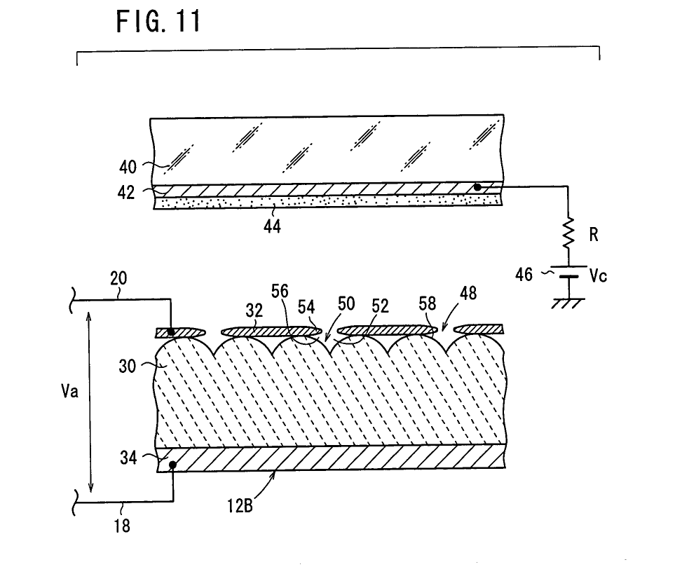

The electron emitter 12B according to the second specific example will be described below with reference to FIGS. 11 through 27C.

As shown in FIG. 11, the upper electrode 32 of the electron emitter 12B has a plurality of through regions 48 where the emitter 30 is exposed. The emitter 30 has an uneven pattern 50 of the grain boundary of a dielectric material that the emitter 30 is made of. The through regions 48 of the upper electrode 32 are formed in areas corresponding to concavities 52 of the grain boundary of the dielectric material. In the example shown in FIG. 11, one through region 48 is formed in association with one concavity 52. However, one through region 48 may be formed in association with a plurality of concavities 52. The through regions 48 may be reduced in size by adjusting the material and/or sintering conditions of the upper electrode 32. In this manner, a plurality of through regions 48 may be formed in one concavity 52 or a through region 48 may be formed on a convexity 58 at the grain boundary of the dielectric material. The particle diameter of the dielectric material of the emitter 30 should preferably be in the range from 0.1 μm to 10 μm, and more preferably be in the range from 2 μm to 7 μm. In the example shown in FIG. 11, the particle diameter of the dielectric material is of 3 μm.

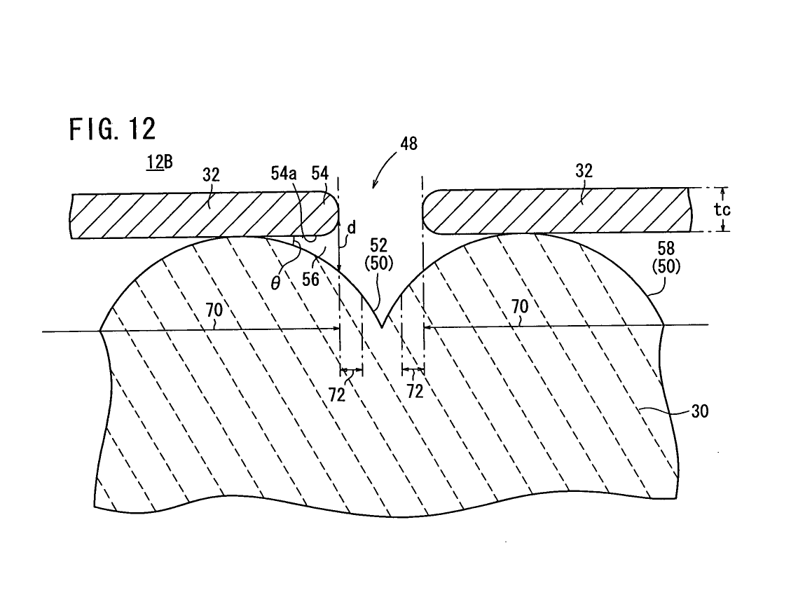

As shown in FIG. 12, according to the second specific example, each of the through regions 48 of the upper electrode 32 has a peripheral portion 54 having a surface 54a facing the emitter 30, the surface 54a being spaced from the emitter 30. Specifically, a gap 56 is formed between the surface 54a, facing the emitter 30, of the peripheral portion 54 of the through region 48 and the emitter 30, and the peripheral portion 54 of the through region 48 of the upper electrode 32 is formed as an overhanging portion (flange). In the description which follows, “the peripheral portion 54 of the through region 48 of the upper electrode 32” is referred to as “the overhanging portion 54 of the upper electrode 32”. In FIGS. 11, 12, 14A, 14B, 15A, 15B, 17, 19, and 24, convexities 58 of the uneven pattern 50 of the grain boundary of the dielectric material are shown as having a semicircular cross-sectional shape. However, the convexities 58 are not limited to the semicircular cross-sectional shape.

According to the second specific example, the upper electrode 32 has a thickness tc in the range of 0.01 μm≦tc≦10 μm, and the maximum angle θ between the upper surface of the emitter 30, i.e., the surface of the convexity 58 (which is also the inner wall surface of the concavity 52) of the grain boundary of the dielectric material, and the lower surface 54a of the overhanging portion 54 of the upper electrode 32 is in the range of 1°≦θ≦60°. The maximum distance d in the vertical direction between the surface of the convexity 58 (the inner wall surface of the concavity 52) of the grain boundary of the dielectric material of the emitter 30 and the lower surface 54a of the overhanging portion 54 of the upper electrode 32 is in the range of 0 μm<d=10 μm.

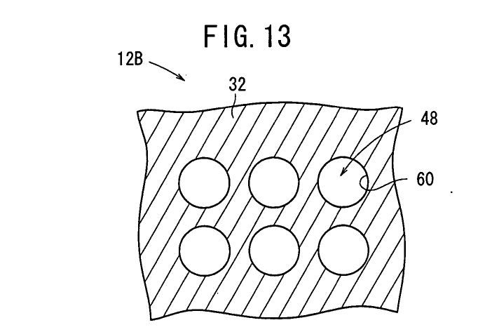

According to the second specific example, the shape of the through region 48, particularly the shape as seen from above, as shown in FIG. 13, is the shape of a hole 60, which may be a circular shape, an elliptical shape, a shape including a curve such as a track shape, or a polygonal shape such as a quadrangular shape or a triangular shape. In FIG. 13, the shape of the hole 60 is a circular shape.

The hole 60 has an average diameter ranging from 0.1 μm to 10 μm. The average diameter represents the average of the lengths of a plurality of different line segments passing through the center of the hole 60. If the through regions 48 are reduced in size by adjusting the material and/or sintering conditions of the upper electrode 32, then the average diameter of the hole 60 may be in the range from 0.05 μm to 0.1 μm. If the through regions 48 are reduced in size and highly integrated, then the amount of emitted electrons (the level of an electron flow) and the electron emission efficiency are increased.

The emitter 30 is made of the same material as the emitter 30 of the electron emitter 12A according to the first embodiment described above. Therefore, the material of the emitter 30 will not be described in detail below.

The emitter 30 may be made by any of various thick-film forming processes including screen printing, dipping, coating, electrophoresis, aerosol deposition, powder jet deposition (film growth based on high-speed ejection of fine particles under the atmospheric pressure), etc., or any of various thin-film forming processes including an ion beam process, sputtering, vacuum evaporation, ion plating, chemical vapor deposition (CVD), plating, etc. Particularly, it is preferable to form a powdery piezoelectric/electrostrictive material as the emitter 30 and impregnate the emitter 30 thus formed with glass of a low melting point or sol particles. According to this process, it is possible to form a film at a low temperature of 700° C. or lower or 600° C. or lower.

The upper electrode 32 should preferably be made of an organic metal paste which can produce a thin film after being baked. For example, a platinum resinate paste or the like should preferably be used. An oxide electrode for suppressing a polarization inversion fatigue, which is made of ruthenium oxide (RuO₂), iridium oxide (IrO₂), strontium ruthenate (SrRuO₃), La₁₋ₓSrₓCoO₃ (e.g., x=0.3 or 0.5), La₁₋ₓCaₓMnO₃ (e.g., x=0.2), La₁₋ₓCaₓMn_{1-y}CO_{y}O₃ (e.g., x=0.2, y=0.05), or a mixture of any one of these compounds and a platinum resinate paste, for example, is preferable. A mixture of a platinum resinate paste and a gold resinate paste or an iridium resinate paste is also preferable as it allows small through regions 48 to be easily formed.

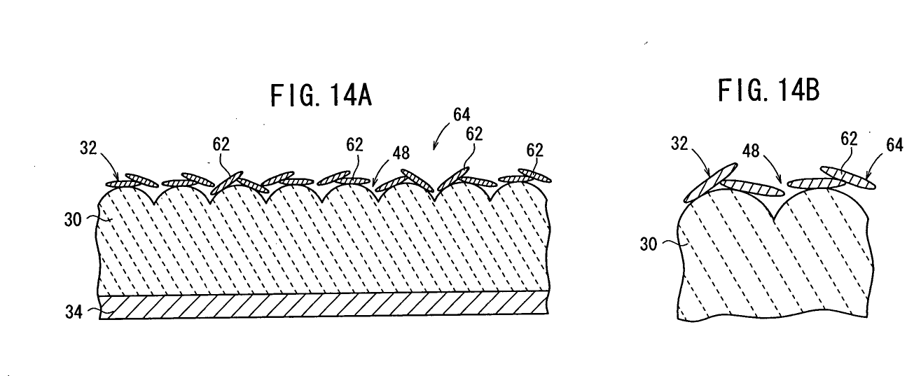

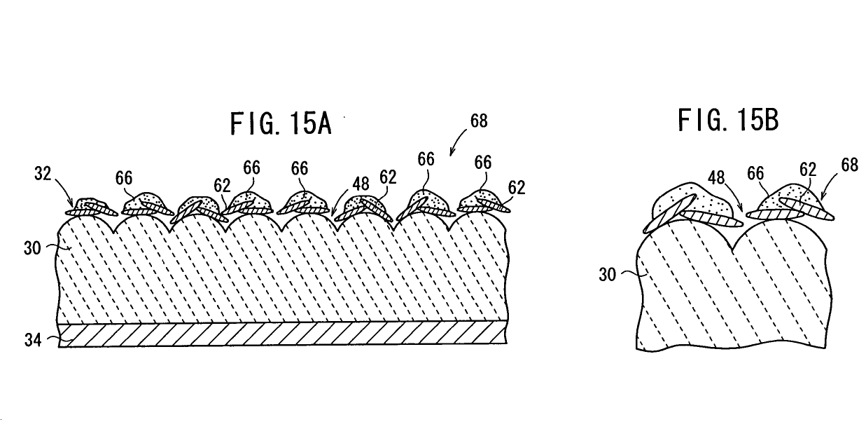

As shown in FIGS. 14A and 14B, the upper electrode 32 may preferably be in the form of a first cluster 64 of a plurality of scale-like members 62 (e.g., of graphite). Alternatively, as shown in FIGS. 15A and 15B, the upper electrode 32 may preferably be in the form of a second cluster 68 of electrically conductive members 66 including scale-like members 62. The first cluster 64 or the second cluster 68 does not fully cover the surface of the emitter 30, but a plurality of through regions 48 are provided through which the emitter 30 is partly exposed, and those portions of the emitter 30 which face the through regions 48 serve as electron emission regions.

The upper electrode 32 may be made of any of the above materials by any of thick-film forming processes including screen printing, spray coating, coating, dipping, electrophoresis, etc., or any of various thin-film forming processes including sputtering, an ion beam process, vacuum evaporation, ion plating, chemical vapor deposition (CVD), plating, etc. Preferably, the upper electrode 32 is made by any of the above thick-film forming processes.

The lower electrode 34 is made of an electrically conductive material, e.g., a metal such as platinum, molybdenum, tungsten, or the like. Alternatively, the lower electrode 34 is made of an electric conductor which is resistant to a high-temperature oxidizing atmosphere, e.g., a metal, an alloy, a mixture of insulative ceramics and a metal, a mixture of insulative ceramics and an alloy, or the like. Preferably, the lower electrode 34 should be made of a precious metal having a high melting point such as platinum, iridium, palladium, rhodium, molybdenum, or the like, or a material chiefly composed of an alloy of silver and palladium, silver and platinum, platinum and palladium, or the like, or a cermet of platinum and ceramics. Further preferably, the lower electrode 34 should be made of platinum only or a material chiefly composed of a platinum-base alloy.

The lower electrode 34 may be made of carbon or a graphite-base material. Ceramics to be added to the electrode material should preferably have a proportion ranging from 5 to 30 volume %. The lower electrode 34 may be made of the same material as the upper electrode 32, as described above.

The lower electrode 34 should preferably be formed by any of the various thick-film forming processes described above. The lower electrode 34 has a thickness of 20 μm or less or preferably a thickness of 5 μm or less.

Each time the emitter 30, the upper electrode 32, or the lower electrode 34 is formed, the assembly is heated (sintered) into an integral structure.

The sintering process for integrally combining the emitter 30, the upper electrode 32, and the lower electrode 34 may be carried out at a temperature ranging from 500 to 1400° C., preferably from 1000 to 1400° C. For heating the emitter 30 which is in the form of a film, the emitter 30 should be sintered together with its evaporation source while their atmosphere is being controlled, so that the composition of the emitter 30 will not become unstable at high temperatures.

By performing the sintering process, the film which will serve as the upper electrode 32 is shrunk from the thickness of 10 μm to the thickness of 0.1 μm, and simultaneously a plurality of holes are formed therein. As a result, as shown in FIG. 11, a plurality of through regions 48 are formed in the upper electrode 32, and the peripheral portions 54 of the through regions 48 are turned into overhanging portions. In advance (of the sintering process), the film which will serve as the upper electrode 32 may be patterned by etching (wet etching or dry etching) or lift-off, and then may be sintered. In this case, recesses or slits may easily be formed as the through regions 48.

The emitter 30 may be covered with a suitable member, and then sintered such that the surface of the emitter 30 will not be exposed directly to the sintering atmosphere.

The principles of electron emission of the electron emitter 12B will be described below. First, a drive voltage Va is applied between the upper electrode 32 and the lower electrode 34. The drive voltage Va is defined as a voltage, such as a pulse voltage or an alternating-current voltage, which abruptly changes with time from a voltage level that is higher or lower than a reference voltage (e.g., 0 V) to a voltage level that is lower or higher than the reference voltage.

A triple junction is formed in a region of contact between the upper surface of the emitter 30, the upper electrode 32, and a medium (e.g., a vacuum) around the electron emitter 12. The triple junction is defined as an electric field concentration region formed by a contact between the upper electrode 32, the emitter 30, and the vacuum. The triple junction includes a triple point where the upper electrode 32, the emitter 30, and the vacuum exist as one point. The vacuum level in the atmosphere should preferably be in the range from 10² to 10⁻⁶ Pa and more preferably in the range from 10⁻³ to 10⁻⁵ Pa.

According to the second specific example, the triple junction is formed on the overhanging portion 54 of the upper electrode 32 and the peripheral area of the upper electrode 32. Therefore, when the above drive voltage Va is applied between the upper electrode 32 and the lower electrode 34, an electric field concentration occurs at the triple junction.

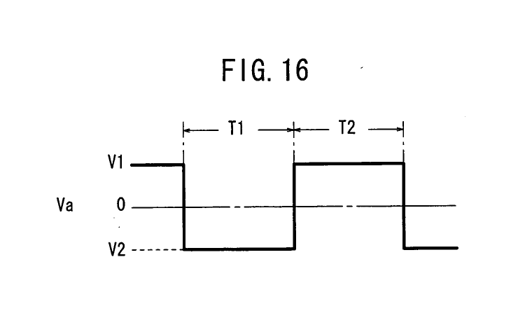

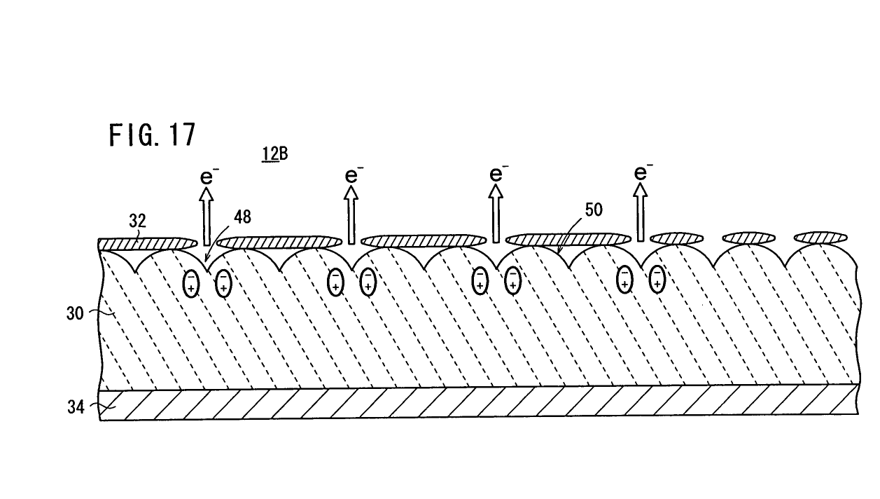

A first electron emission process for the electron emitter 12B will be described below with reference to FIGS. 16 and 17. In a first output period T1 (first stage) shown in FIG. 16, a voltage V2 lower than a reference voltage (e.g., 0 V) is applied to the upper electrode 32, and a voltage V1 higher than the reference voltage is applied to the lower electrode 34. In the first output period T1, an electric field concentration occurs at the triple junction referred to above, causing the upper electrode 32 to emit primary electrons toward the emitter 30. The emitted electrons are accumulated in the portions of the emitter 30 which are exposed through the through region 48 of the upper electrode 32 and the regions near the outer peripheral portion of the upper electrode 32, thus charging the emitter 30. At this time, the upper electrode 32 functions as an electron supply source.

In a second output period T2 (second stage), the voltage level of the drive voltage Va abruptly changes, i.e., the voltage V1 higher than the reference voltage is applied to the upper electrode 32, and the voltage V2 lower than the reference voltage is applied to the lower electrode 34. The electrons that have been accumulated in the portions of the emitter 30 which are exposed through the through region 48 of the upper electrode 32 and the regions near the outer peripheral portion of the upper electrode 32 are expelled from the emitter 30 by dipoles (whose negative poles appear on the surface of the emitter 30) in the emitter 30 whose polarization has been inverted in the opposite direction. As shown in FIG. 17, the electrons are emitted from the portions of the emitter 30 where the electrons have been accumulated, through the through regions 48. The electrons are also emitted from the regions near the outer peripheral portion of the upper electrode 32 to form an electron flow as a whole.

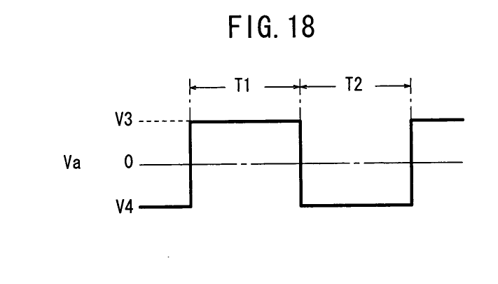

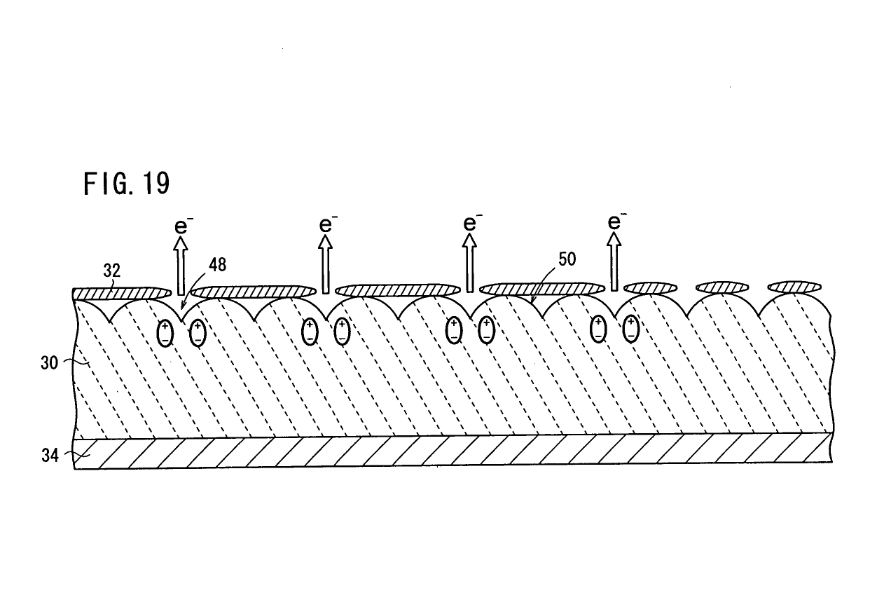

A second electron emission process will be described below. In a first output period T1 (first stage) shown in FIG. 18, a voltage V3 higher than the reference voltage is applied to the upper electrode 32, and a voltage V4 lower than the reference voltage is applied to the lower electrode 34. In the first output period T1, the electron emitter 12 is prepared for electron emission (e.g., the emitter 30 is polarized in one direction). In a second output period T2 (second stage), the voltage level of the drive voltage Va abruptly changes, i.e., the voltage V4 lower than the reference voltage is applied to the upper electrode 32, and the voltage V3 higher than the reference voltage is applied to the lower electrode 34. An electric field concentration occurs at the triple junction referred to above, causing the upper electrode 32 to emit primary electrons, which impinge upon the portions of the emitter 30 which are exposed through the through region 48 and the regions near the outer peripheral portion of the upper electrode 32. As shown in FIG. 19, secondary electrons (including reflected primary electrons) are emitted from the portions hit by the primary electrons. Thus, secondary electrons are emitted from the through region 48 and the regions near the outer peripheral portion of the upper electrode 32 in an initial stage of the second output period T2.

Since the upper electrode 32 of the electron emitter 12B has the plural through regions 48, electrons are uniformly emitted from each of the through regions 48 and the outer peripheral portions of the upper electrode 32. Thus, any variations in the overall electron emission characteristics of the electron emitter 12B are reduced, making it possible to facilitate the control of the electron emission and increase the electron emission efficiency.

According to the second specific example, because the gap 56 is formed between the overhanging portion 54 of the upper electrode 32 and the emitter 30, when the drive voltage Va is applied, an electric field concentration tends to be produced in the region of the gap 56. This leads to a higher efficiency of the electron emission, making the drive voltage lower (emitting electrons at a lower voltage level).

According to the second specific example, as described above, since the upper electrode 32 has the overhanging portion 54 on the peripheral portion of the through region 48, together with the increased electric field concentration in the region of the gap 56, electrons are easily emitted from the overhanging portion 54 of the upper electrode 32. This leads to a larger output and higher efficiency of the electron emission, making the drive voltage Va lower. The light source 10, which has a number of arrayed electron emitters 12, has a higher level of luminance.

According to either the first electron emission process (which emits electrons accumulated in the emitter 30) or the second electron emission process (which emits secondary electrons by forcing primary electrons from the upper electrode 32 into impingement upon the emitter 30), as the overhanging portion 54 of the upper electrode 32 functions as a gate electrode (a control electrode, a focusing electronic lens, or the like), the tendency of the emitted electrons to travel straight can be increased. This is effective in reducing crosstalk if a number of electron emitters 12 are arrayed for use as an electron source of displays.

The electron emitter 12B according to the second specific example is capable of easily developing a high electric field concentration, provides many electron emission regions, has a larger output and higher efficiency of the electron emission, and can be driven at a lower voltage (lower power consumption).

According to the second specific example, in particular, at least the upper surface of the emitter 30 has the uneven pattern 50 of the grain boundary of the dielectric material. As the upper electrode 32 has the through regions 48 in portions corresponding to the concavities 52 of the grain boundary of the dielectric material, the overhanging portions 54 of the upper electrode 32 can easily be realized.

The maximum angle θ between the upper surface of the emitter 30, i.e., the surface of the convexity 58 (which is also the inner wall surface of the concavity 52) of the grain boundary of the dielectric material, and the lower surface 54a of the overhanging portion 54 of the upper electrode 32 is in the range of 1°≦θ≦60°. The maximum distance d in the vertical direction between the surface of the convexity 58 (the inner wall surface of the concavity 52) of the grain boundary of the dielectric material of the emitter 30 and the lower surface 54a of the overhanging portion 54 of the upper electrode 32 is in the range of 0 μm<d≦10 μm. These arrangements make it possible to increase the degree of the electric field concentration in the region of the gap 56, resulting in a larger output and higher efficiency of the electron emission and making the drive voltage lower efficiently.

According to the second specific example, the through region 48 is in the shape of the hole 60. As shown in FIG. 12, the portions of the emitter 30 where the polarization is inverted or changed depending on the drive voltage Va applied between the upper electrode 32 and the lower electrode 34 (see FIG. 11) include a portion (first portion 70) directly below the upper electrode 32 and a portion (second portion 72) corresponding to a region extending from the inner peripheral edge of the through region 48 to the inward of the through region 48. Particularly, the second portion 72 changes depending on the level of the drive voltage Va and the degree of the electric field concentration. In the second specific example, the electron emitter 12, the average diameter of the hole 60 is in the range from 0.1 μm to 10 μm. Insofar as the average diameter of the hole 60 is in this range, the distribution of electrons emitted through the through region 48 is almost free of any variations, allowing electrons to be emitted efficiently.

If the upper electrode 32 comprises an alloy electrode chiefly made of a Pt resinate paste and the sintering conditions are adjusted, then the average diameter of the hole 60 may be less than 0.1 μm. Particularly, if the temperature is quickly increased in the sintering process, then it is possible to form holes 60 having an average diameter less than 0.1 μm at a high density. If the average diameter of the hole 60 is in excess of 10 μm, then the proportion (share) of the portion (second portion) 72 which contributes to the emission of electrons in the portion of the emitter 30 that is exposed through the through region 48 is reduced, resulting in a reduction in the electron emission efficiency.

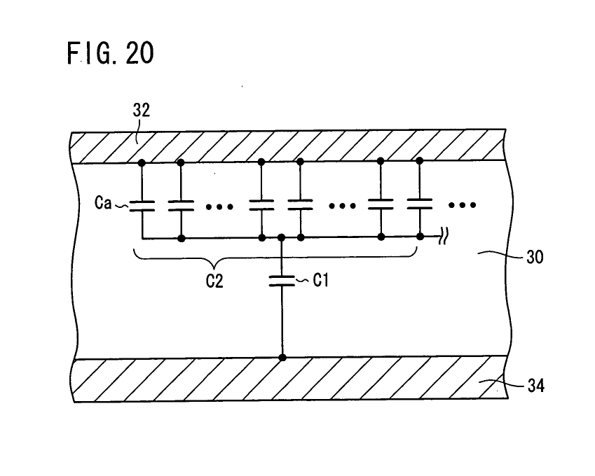

According to the second specific example, as shown in FIG. 20, the electron emitter 12B has in its electrical operation a capacitor C1 due to the emitter 30 and a cluster of capacitors Ca due to respective gaps 56, disposed between the upper electrode 32 and the lower electrode 34. The capacitors Ca due to the respective gaps 56 are connected parallel to each other into a single capacitor C2. In terms of an equivalent circuit, the capacitor C1 due to the emitter 30 is connected in series to the capacitor C2 which comprises the cluster of capacitors Ca.

Actually, the capacitor C1 due to the emitter 30 is not directly connected in series to the capacitor C2 which comprises the cluster of capacitors Ca, but the capacitive component that is connected in series varies depending on the number of the through regions 48 formed in the upper electrode 32 and the overall area of the through regions 48.

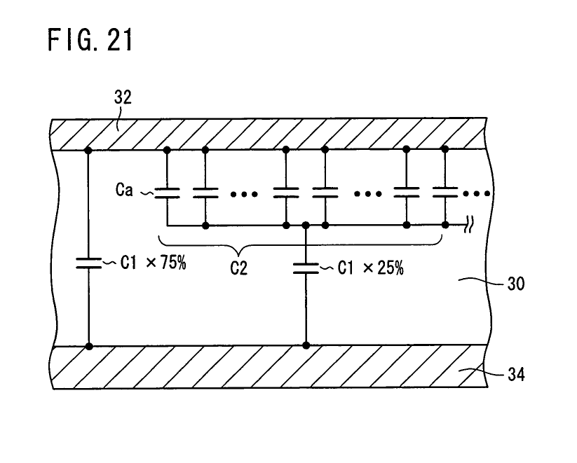

Capacitance calculations will be performed on the assumption that 25% of the capacitor C1 due to the emitter 30 is connected in series to the capacitor C2 which comprises the cluster of capacitors Ca, as shown in FIG. 21. Since the gaps 56 are in vacuum, the relative dielectric constant thereof is 1. It is assumed that the maximum distance d across the gaps 56 is 0.1 μm, the area S of each gap 56 is S=1 μm×1 μm, and the number of the gaps 56 is 10,000. It is also assumed that the emitter 30 has a relative dielectric constant of 2000, the emitter 30 has a thickness of 20 μm, and the confronting area of the upper and lower electrodes 32, 34 is 200 μm×200 μm. The capacitor C2 which comprises the cluster of capacitors Ca has a capacitance of 0.885 pF, and the capacitor C1 due to the emitter 30 has a capacitance of 35.4 pF. If the portion of the capacitor C1 due to the emitter 30 which is connected in series to the capacitor C2 which comprises the cluster of capacitors Ca is 25% of the entire capacitor C1, then that series-connected portion has a capacitance (including the capacitance of capacitor C2 which comprises the cluster of capacitors Ca) of 0.805 pF, and the remaining portion has a capacitance of 26.6 pF.

Because the series-connected portion and the remaining portion are connected parallel to each other, the overall capacitance is 27.5 pF. This capacitance is 78% of the capacitance 35.4 pF of the capacitor C1 due to the emitter 30. Therefore, the overall capacitance is smaller than the capacitance of the capacitor C1 due to the emitter 30.

Consequently, the capacitance of the cluster of capacitors Ca due to the gaps 56 is relatively small. Because of the voltage division between the cluster of capacitors Ca and the capacitor C1 due to the emitter 30, almost the entire applied voltage Va is applied across the gaps 56, which are effective to produce a larger output of the electron emission.

Since the capacitor C2 which comprises the cluster of capacitors Ca is connected in series to the capacitor C1 due to the emitter 30, the overall capacitance is smaller than the capacitance of the capacitor C1 due to the emitter 30. This is effective to provide such preferred characteristics that the electron emission is performed for a larger output and the overall power consumption is lower.

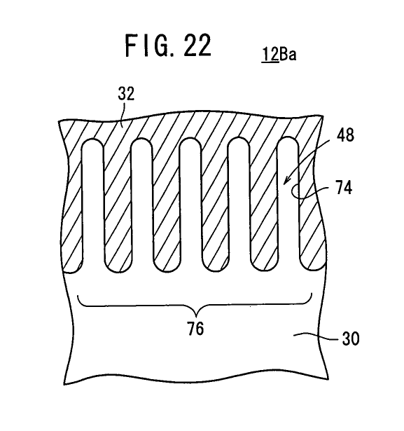

Three modifications of the electron emitter 12B according to the second specific example will be described below with reference to FIGS. 22 through 24.

As shown in FIG. 22, an electron emitter 12Ba according to a first modification differs from the above electron emitter 12B in that the through region 48 has a shape, particularly a shape viewed from above, in the form of a recess 74. As shown in FIG. 22, the recess 74 should preferably be shaped such that a number of recesses 74 are successively formed into a saw-toothed recess 76. The saw-toothed recess 76 is effective to reduce variations in the distribution of electrons emitted through the through region 48 for efficient electron emission. Particularly, it is preferable to have the average width of the recesses 76 in the range from 0.05 μm to 10 μm. The average width represents the average of the lengths of a plurality of different line segments extending perpendicularly across the central line of the recess 74.

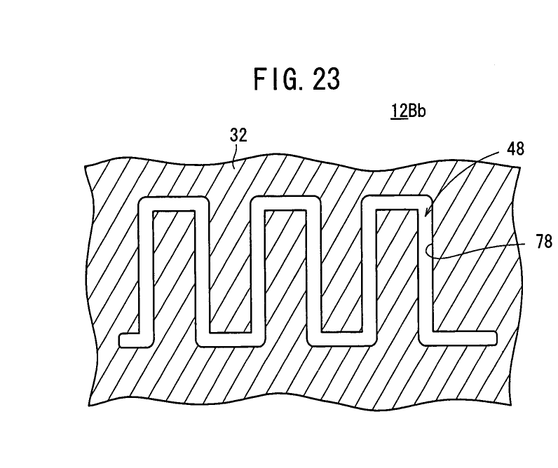

As shown in FIG. 23, an electron emitter 12Bb according to a second modification differs from the above electron emitter 12B in that the through region 48 has a shape, particularly a shape viewed from above, in the form of a slit 78. The slit 78 is defined as something having a major axis (extending in a longitudinal direction) whose length is 10 times or more the length of the minor axis (extending in a transverse direction) thereof. Those having a major axis (extending in a longitudinal direction) whose length is less than 10 times the length of the minor axis (extending in a transverse direction) thereof are defined as holes 60 (see FIG. 13). The slit 78 includes a succession of holes 60 in communication with each other. The slit 78 should preferably have an average width ranging from 0.05 μm to 10 μm for reducing variations in the distribution of electrons emitted through the through region 48 for efficient electron emission. The average width represents the average of the lengths of a plurality of different line segments extending perpendicularly across the central line of the slit 78.

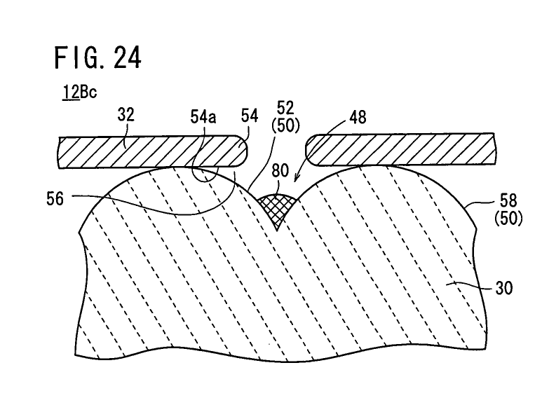

As shown in FIG. 24, an electron emitter 12Bc according to a third modification differs from the above electron emitter 12B in that a floating electrode 80 exists on the portion of the upper surface of the emitter 30 which corresponds to the through region 48, e.g., in the concavity 52 of the grain boundary of the dielectric material. With this arrangement, as the floating electrode 80 functions as an electron supply source, the electron emitter 12Bc can emit many electrons through the through region 48 in an electron emission stage (the second output period T2 (see FIG. 16) according to the first electron emission process described above). The electron emission from the floating electrode 80 may be attributed to an electric field concentration at the triple junction of the floating electrode 80, the dielectric material, and the vacuum.

The characteristics of the electron emitter 12B according to the second specific example, particularly, the voltage vs. charge quantity characteristics (the voltage vs. polarization quantity characteristics) thereof will be described below.

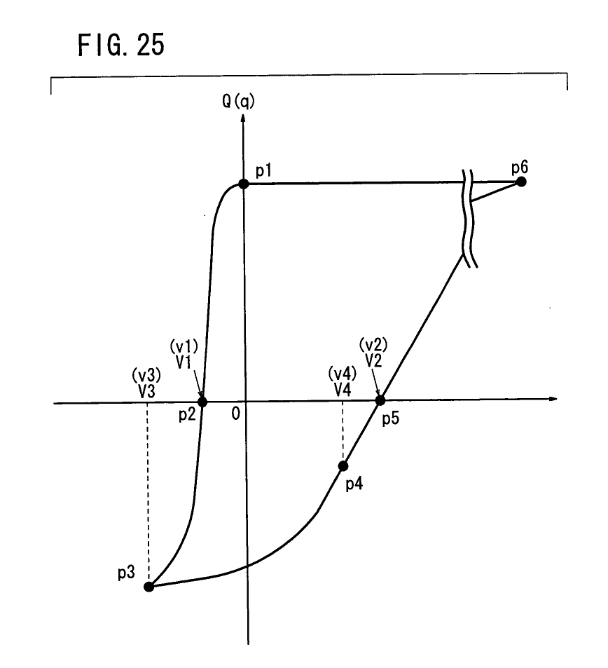

The electron emitter 12B is characterized by an asymmetric hysteresis curve based on the reference voltage=0 (V) in vacuum, as indicated by the characteristics shown in FIG. 25.

The voltage vs. charge quantity characteristics will be described below. If a region of the emitter 30 from which electrons are emitted is defined as an electron emission region, then at a point p1 (initial state) where the reference voltage is applied, almost no electrons are stored in the electron emission region. Thereafter, when a negative voltage is applied, the amount of positive charges of dipoles whose polarization is inverted in the emitter 30 in the electron emission region increases, and electrons are emitted from the upper electrode 32 toward the electron emission region in the first stage, so that electrons are stored. When the absolute value of the negative voltage increases, electrons are progressively stored in the electron emission region until the amount of positive charges and the amount of electrons are held in equilibrium with each other at a point p2 of the negative voltage. As the absolute value of the negative voltage further increases, the stored amount of electrons increases, making the amount of negative charges greater than the amount of positive charges. The accumulation of electrons is saturated at a point P3. The amount of negative charges is the sum of the amount of electrons remaining to be stored and the amount of negative charges of the dipoles whose polarization is inverted in the emitter 30.

When the absolute value of the negative voltage subsequently decreases, and a positive voltage is applied in excess of the reference voltage, electrons start being emitted at a point p4 in the second stage. When the positive voltage increases in a positive direction, the amount of emitted electrons increases until the amount of positive charges and the amount of electrons are held in equilibrium with each other at a point p5. At a point p6, almost all the stored electrons are emitted, bringing the difference between the amount of positive charges and the amount of negative charges into substantial conformity with a value in the initial state. That is, almost all stored electrons are eliminated, and only the negative charges of dipoles whose polarization is inverted in the emitter 30 appear in the electron emission region.

The voltage vs. charge quantity characteristics have the following features:

(1) If the negative voltage at the point p2 where the amount of positive charges and the amount of electrons are held in equilibrium with each other is represented by V1 and the positive voltage at the point p5 is represented by V2, then these voltages satisfy the following relationship:
|V1|<|V2|

(2) More specifically, the relationship is expressed as
1.5×|V1|<|V2|

(3) If the rate of change of the amount of positive charges and the amount of electrons at the point p2 is represented by ΔQ1/ΔV1 and the rate of change of the amount of positive charges and the amount of electrons at the point p5 by ΔQ2/ΔV2, then these rates satisfy the following relationship:
(ΔQ1/ΔV1)>(ΔQ2/ΔV2)

(4) If the voltage at which the accumulation of electrons is saturated is represented by V3 and the voltage at which electrons start being emitted is represented by V4, then these voltages satisfy the following relationship:
1≦|V4|/|V3|≦1.5

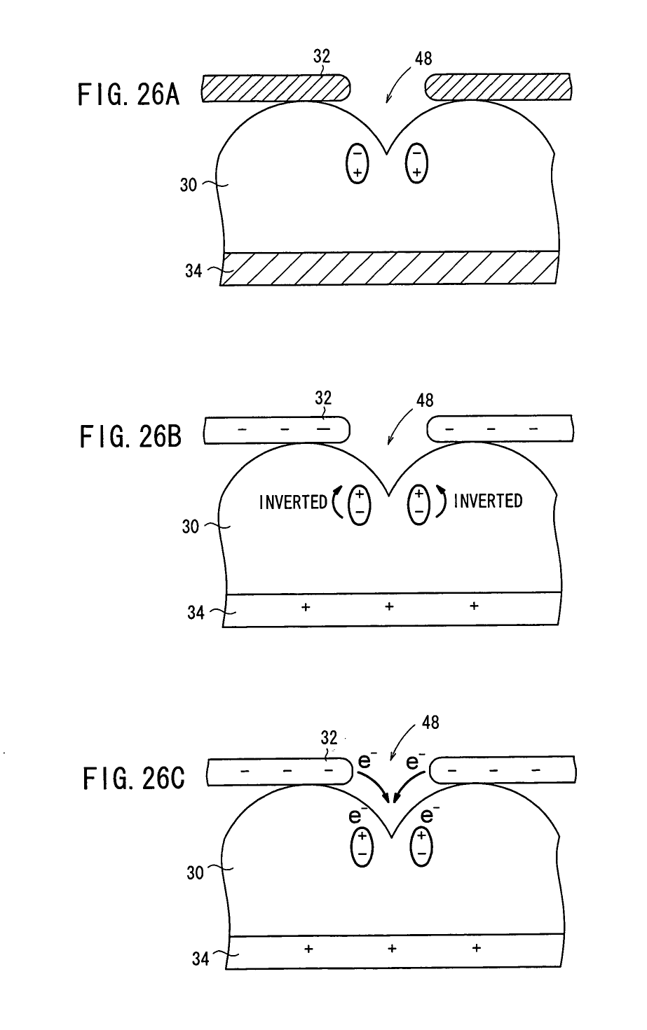

The characteristics shown in FIG. 25 will be described below in terms of the voltage vs. polarization quantity characteristics. It is assumed that the emitter 30 is polarized in one direction, with dipoles having negative poles facing toward the upper surface of the emitter 30 (see FIG. 26A).

At the point p1 (initial state) where the reference voltage (e.g., 0 V) is applied as shown in FIG. 25, since the negative poles of the dipole moments face toward the upper surface of the emitter 30, as shown in FIG. 26A, almost no electrons are accumulated on the upper surface of the emitter 30.

Thereafter, when a negative voltage is applied and the absolute value of the negative voltage is increased, the polarization starts being inverted substantially at the time the negative voltage exceeds a negative coercive voltage (see the point p2 in FIG. 25). All the polarization is inverted at the point p3 shown in FIG. 25 (see FIG. 26B). Because of the polarization inversion, an electric field concentration occurs at the triple junction, and the upper electrode 32 emits electrons toward the emitter 30 in the first stage, causing electrons to be accumulated in the portion of the emitter 30 which is exposed through the through region 48 of the upper electrode 32 and the portion of the emitter 30 which is near the peripheral portion of the upper electrode 32 (see FIG. 26C). In particular, electrons are emitted (emitted inwardly) from the upper electrode 32 toward the portion of the emitter 30 which is exposed through the through region 48 of the upper electrode 32. At the point p3 shown in FIG. 25, the accumulation of electrons is saturated.

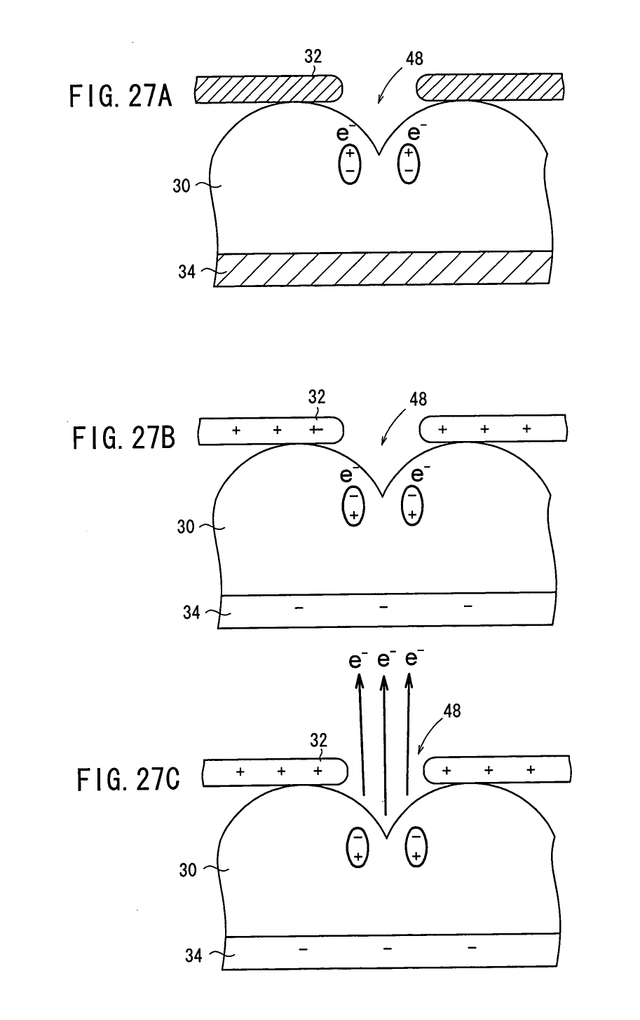

Thereafter, when the absolute value of the negative voltage is reduced and a positive voltage is applied in excess of the reference voltage, the upper surface of the emitter 30 is kept charged up to a certain voltage level (see FIG. 27A). As the level of the positive voltage is increased, there is produced a region where the negative poles of dipoles start facing the upper surface of the emitter 30 (see FIG. 27B) immediately prior to the point p4 in FIG. 25. When the level is further increased, electrons start being emitted due to coulomb repulsive forces posed by the negative poles of the dipoles after the point p4 in FIG. 25 (see FIG. 27C). When the positive voltage is increased in the positive direction, the amount of emitted electrons is increased. Substantially at the time the positive voltage exceeds the positive coercive voltage (the point p5), a region where the polarization is inverted again is increased. At the point p6, almost all the accumulated electrons are emitted, and the amount of polarization at this time is essentially the same as the amount of polarization in the initial state.

The characteristics of the electron emitter 12 have the following features:

(A) If the negative coercive voltage is represented by v1 and the positive coercive voltage by v2, then
|v1|<|v2|

(B) More specifically, 1.5×|v1|<|v2|

(C) If the rate of change of the polarization at the time the negative coercive voltage v1 is applied is represented by Δq1/Δv1 and the rate of change of the polarization at the time the positive coercive voltage v2 is applied is represented by Δq2/Δv2, then
(Δq1/Δv1)>(Δq2/Δv2)

(D) If the voltage at which the accumulation of electrons is saturated is represented by v3 and the voltage at which electrons start being emitted by v4, then
1≦|v4/|v3≦1.5

Since the electron emitter 12B has the above characteristics, it can easily be applied to the light source 10 which has a plurality of electron emitters 12B arrayed in association with a plurality of pixels, for emitting light due to the emission of electrons from the electron emitters 12B.

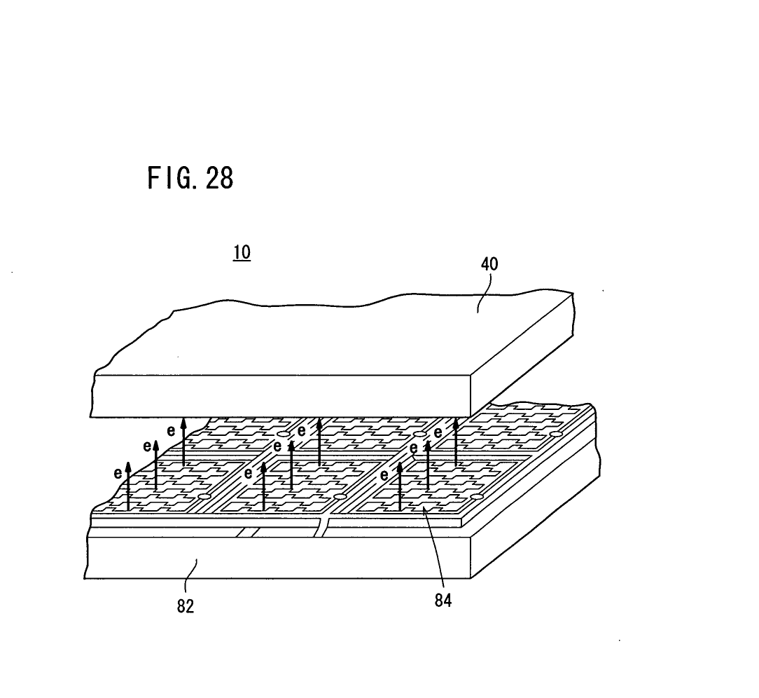

Preferred structures of the light source 10 according to the present embodiment which employs electron emitters 12 described above (the electron emitters 12A, 12B according to the first and second specific examples) will be described below with reference to FIGS. 28 through 35.

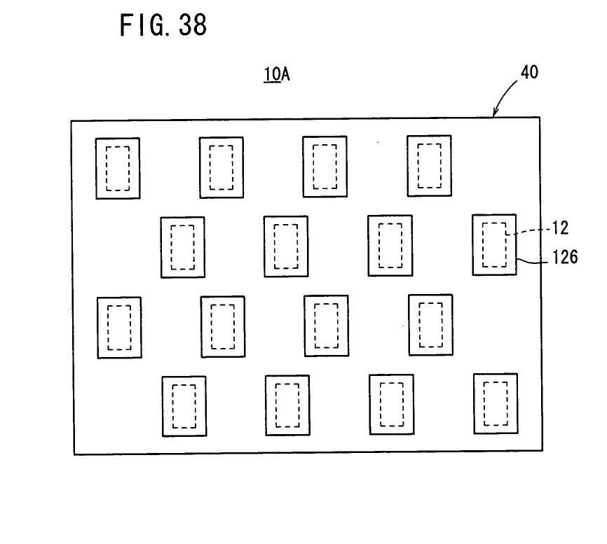

As shown in FIG. 28, the light source 10 according to the present embodiment has the transparent substrate 40 described above and a fixed substrate 82 having a plate surface disposed in facing relation to the reverse side of the transparent substrate 40. The anode electrode 42 in the form of a transparent electrode and the phosphor layer as described above are disposed on the reverse side of the transparent substrate 40. A two-dimensional array of electron emitters 12 as shown in FIG. 38, for example, is disposed on the principal surface of the fixed substrate 82. A vacuum is developed between the transparent substrate 40 and the fixed substrate 82.

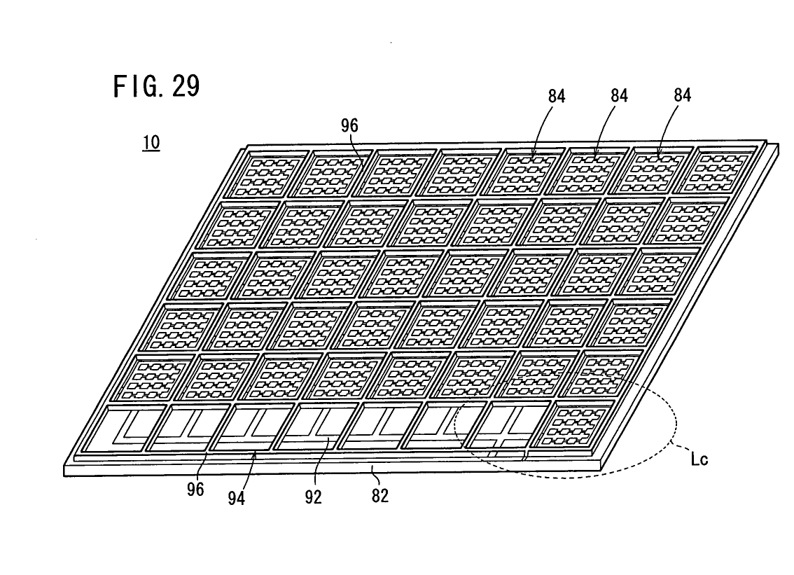

As shown in FIG. 29, the two-dimensional array of the electron emitters 12 may be in the form of a two-dimensional array of rectangular electron emission units 84 (described later).

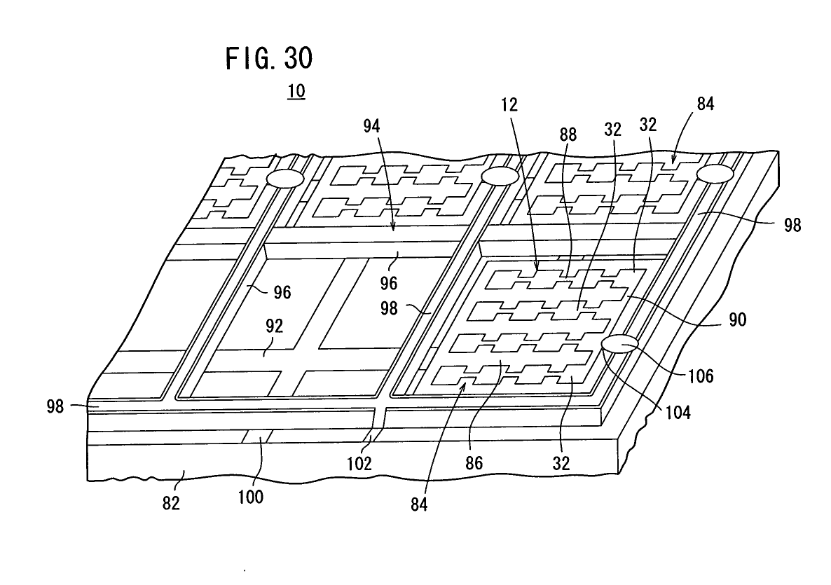

As shown in FIG. 30, each of the electron emission units 84 comprises a single ferroelectric sheet 86 (emitter 30), a matrix of 16 upper electrodes 32, for example, disposed on an upper surface of the ferroelectric sheet 86, and a matrix of lower electrodes 34 (not shown) disposed on a lower surface of the ferroelectric sheet 86 at respective positions aligned with the upper electrodes 32. Specifically, each of the electron emission units 84 comprises a matrix of 16 electron emitters 12.

In the arrangement shown in FIG. 30, in each of the electron emission units 84, the 16 upper electrodes 32 are arranged in four rows and four columns. The four upper electrodes 32 in each row are electrically connected to each other by leads 88, and the four upper electrodes 32 in the rightmost column are electrically connected to each other by leads 90. The lower electrodes 34 are similarly arranged and electrically connected.

A plurality of lower electrode interconnects 92 are disposed on the principal surface of the fixed substrate 82. A frame 94 is mounted on the principal surface of the fixed substrate 82 where the lower electrode interconnects 92 are disposed. The frame 94 has a plurality of rectangular cribs, arranged a matrix, for example, which are defined by a plurality of walls 96 arranged in rows and columns. The electron emission units 84 are inserted respectively in the rectangular cribs. Each of the rectangular cribs as viewed in plan is slightly greater than a single electron emission unit 84, allowing the electron emission units 84 to be easily inserted respectively in the rectangular cribs. In FIGS. 29 and 30, some of the electron emission units 84 are omitted from illustration for making some of the lower electrode interconnects 92 visible.

As shown in FIG. 30, upper electrode interconnects 98 are disposed on the walls 96 of the frame 94. The lower electrode interconnects 92 have a common lead 100, and the upper electrode interconnects 98 have a common lead 102, the common leads 100, 102 extending to one side edge of the fixed substrate 82.

The upper electrode interconnects 98 and the upper electrodes 32 of each of the electron emission units 84 are electrically connected to each other by leads 104 extending from the upper electrodes 32 in the fourth column and electrically connected to the upper electrode interconnects 98 disposed on the walls 96 near the upper electrodes 32 in the fourth column, by an electrically conductive paste 106.

The lower electrode interconnects 92 and the lower electrodes 34 (not shown) in each of the electron emission units 84 are electrically connected to each other by an electrically conductive paste (not shown) applied to the lower electrode interconnects 92 disposed on the principal surface of the fixed substrate 82 and the lower electrodes 34.

As shown in FIG. 28, electrons are emitted from the electron emitters 12 in each of the electron emission units 84 to impinge upon the phosphor layer (not shown) on the reverse side of the transparent substrate 40, exciting the phosphor layer to emit phosphorescent light.

The light source 10 according to the present embodiment is capable of emitting phosphorescent light due to electron excitation in each of the electron emission units 84 at an emission efficiency higher than the emission efficiency of LED light emission. The light source 10 is also advantageous in that it has a reduced burden on the environment because it does not employ mercury.

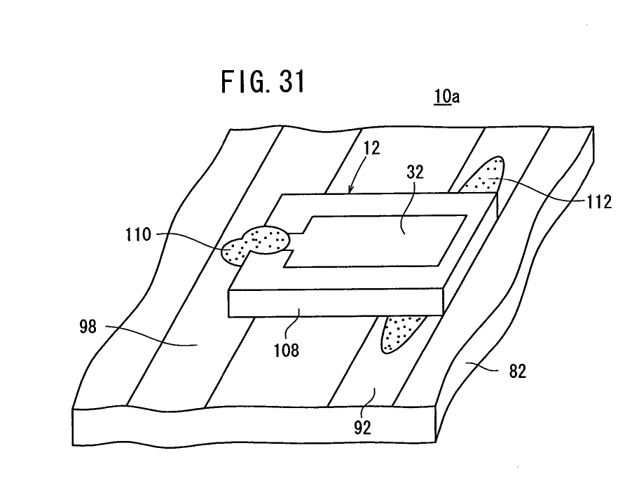

In the above example, the electron emission unit 84 has 16 electron emitters 12. A light source b1a according to a first modification shown in FIG. 31 has a matrix of electron emitters 12 each comprising a ferroelectric chip 108.

Specifically, the light source 10a according to the first modification has a lower electrode interconnect 92 and an upper electrode interconnect 98 provided on a fixed substrate 82 and spaced from and disposed adjacent to each other, and a plurality of electron emitters 12 disposed between and over the lower electrode interconnect 92 and the upper electrode interconnect 98. Each of the electron emitters 12 has an upper electrode 32 disposed on an upper surface of the ferroelectric chip 108 (emitter 30), and a lower electrode 34 (not shown) disposed on a lower surface of the ferroelectric chip 108. The upper electrode 32 and the upper electrode interconnect 98 are electrically connected to each other by an electrically conductive paste 110, and the lower electrode 34 (not shown) and the lower electrode interconnect 92 are electrically connected to each other by an electrically conductive paste 112.

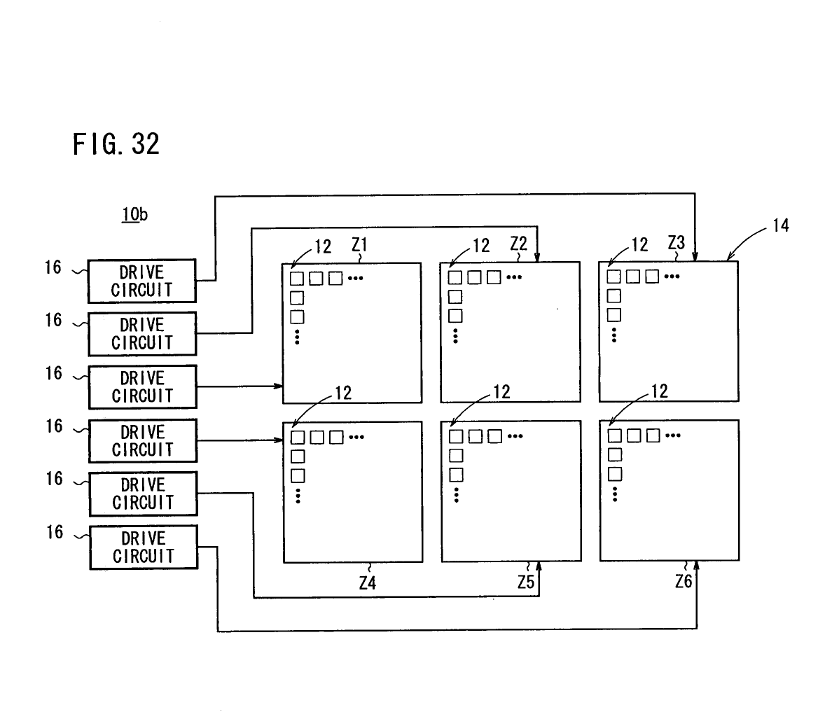

In the above example, the light source has a single light emission section 14 including all the electron emitters 12, and a single drive circuit 16 connected to the light emission section 14. A light source lob according to a second modification shown in FIG. 32 has two or more planar light source sections Z1 through Z6. In the example shown in FIG. 32, the light source lob has six planar light source sections Z1 through Z6. Each of the planar light source sections Z1 through Z6 has a two-dimensional array of electron emitters 12, and drive circuits 16 are independently connected to the respective planar light source sections Z1 through Z6.

Each of the planar light source sections Z1 through Z6 can be controlled for energization/de-energization to perform stepwise light control (digital light control). Particularly, if the drive circuits 16 independently connected respectively to the planar light source sections Z1 through Z6 have modulation circuits, then the light emission distributions of the planar light source sections Z1 through Z6 can independently be controlled. That is, the light source lob can perform analog light control as well as digital light control for fine light control applications.

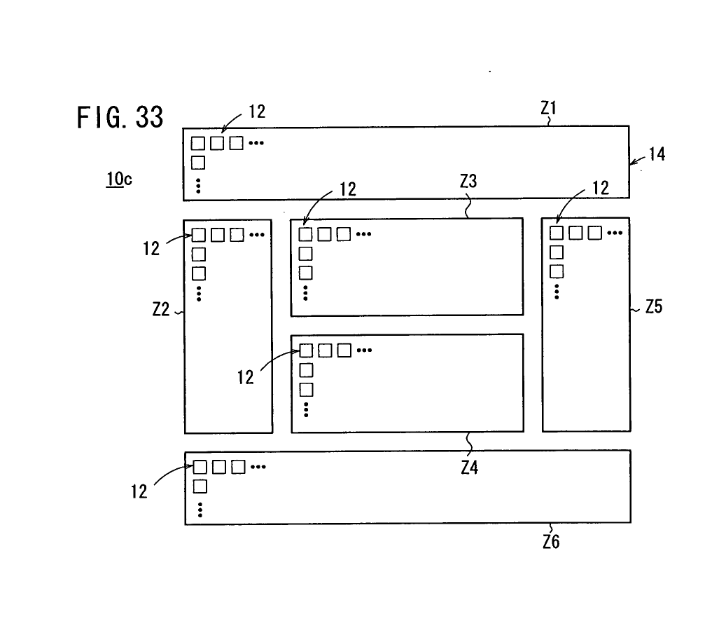

In the example shown in FIG. 32, the planar light source sections Z1 through Z6 have equal areas. However, the planar light source sections Z1 through Z6 may have different areas. For example, FIG. 33 shows a light source 10c according to a third modification which includes first and sixth planar light source sections Z1, Z6 which are of a horizontally long rectangular shape with long sides, second and fifth planar light source sections Z2, Z5 which are of a vertically long rectangular shape with long sides shorter than the long sides of the first and sixth planar light source sections Z1, Z6, and third and fourth planar light source sections Z3, Z4 which are of a horizontally long rectangular shape with long sides shorter than the long sides of the first and sixth planar light source sections Z1, Z6.

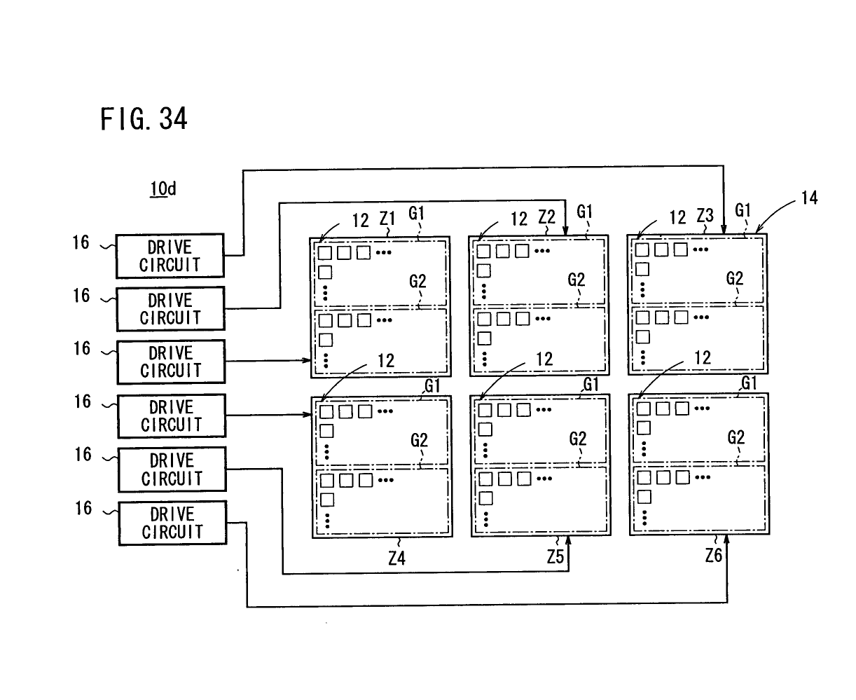

FIG. 34 shows a light source 10d according to a fourth modification. The light source 10d has first through sixth planar light source sections Z1 through Z6. The electron emitters 12 in each of the first through sixth planar light source sections Z1 through Z6 are divided into two groups (first and second groups G1, G2). In each of the first through sixth planar light source sections Z1 through Z6, when the electron emitters 12 in the first group G1 emit light, the electron emitters 12 in the second group G2 retrieve electric power of the electron emitters 12 in the first group G1, and when the electron emitters 12 in the second group G2 emit light, the electron emitters 12 in the first group G1 retrieve electric power of the electron emitters 12 in the second group G2.

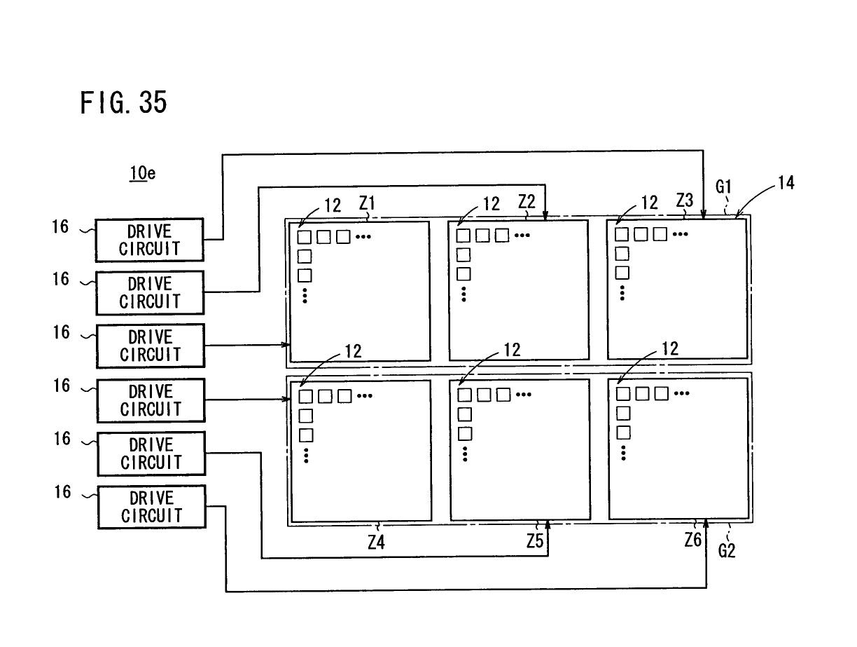

FIG. 35 shows a light source 10e according to a fifth modification. The light source 10e has first through sixth planar light source sections Z1 through Z6. The first through sixth planar light source sections Z1 through Z6 are divided into two groups (first and second groups G1, G2). When the electron emitters 12 in the planar light source sections Z1 through Z3 in the first group G1 emit light, the electron emitters 12 in the planar light source sections Z4 through Z6 in the second group G2 retrieve electric power of the electron emitters 12 in the first group G1, and when the electron emitters 12 in the planar light source sections Z4 through Z6 in the second group G2 emit light, the electron emitters 12 in the planar light source sections Z1 through Z3 in the first group G1 retrieve electric power of the electron emitters 12 in the second group G2.

With the light sources 10b through 10e according to the second through fifth modifications, the light emission section 14 is divided into the six planar light source sections Z1 through Z6. However, the number of planar light source sections is optional.

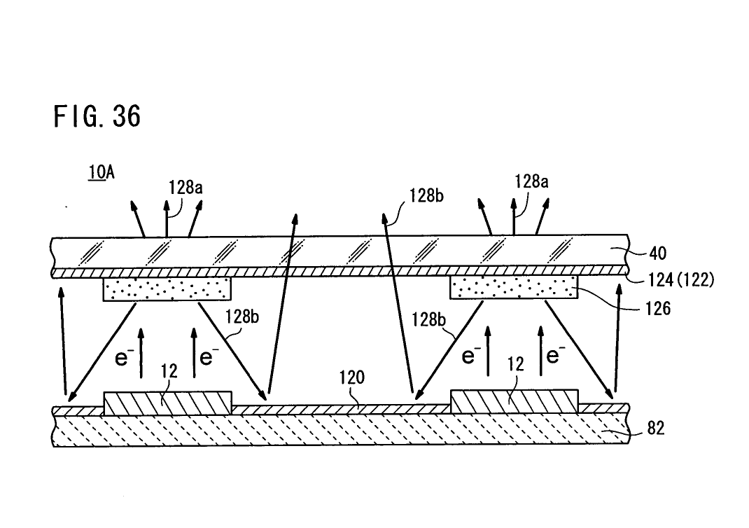

Specific examples of the light source 10 according to the present embodiment will be described below with reference to FIGS. 36 through 57.

As shown in FIG. 36, a light source 10A according to a first specific example has a transparent substrate 40, a fixed substrate 82 disposed in facing relation to the transparent substrate 40, and a plurality of electron emitters 12 disposed on the principal surface of the fixed substrate 82 which faces the transparent substrate 40.

A light reflecting film 120 is disposed on a portion of the principal surface of the fixed substrate 82 which is free of the electron emitters 12. An anode electrode 124 in the form of a transparent electrode 122 is disposed substantially on the entire reverse side of the transparent substrate 40 which faces the fixed substrate 82, and phosphor layers 126 are disposed on the anode electrode 124 at respective positions aligned with the electron emitters 12. The light reflecting film 120 comprises a metal film or a white diffusion layer. The metal film may be formed by vacuum evaporation, or may be in the form of a metal foil applied to the fixed substrate 82. The metal film should preferably be made of Ag or Al as it has a high reflectance and is suitably flexible.

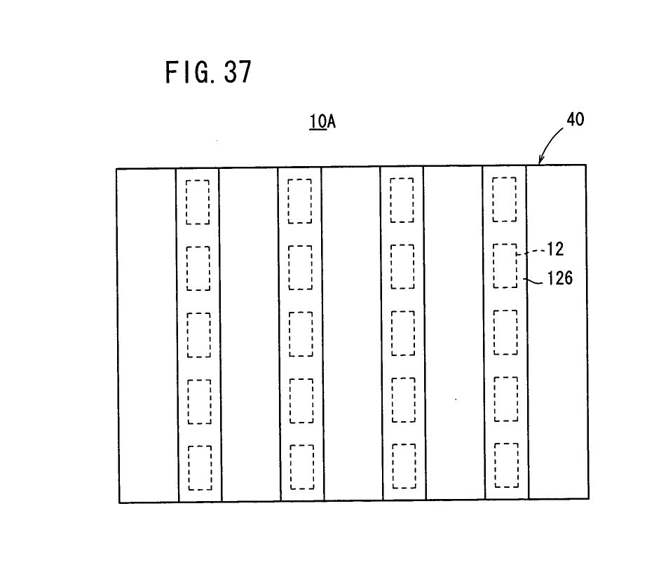

The electron emitters 12 and the phosphor layers 126 may be arrayed in a pattern as shown in FIG. 37 in which the electron emitters 12 are arranged in a matrix and the phosphor layers 126 are provided in the form of a plurality of strips extending along the columns of the matrix of the electron emitters 12. Alternatively, as shown in FIG. 38, the electron emitters 12 may be arranged in a staggered pattern, and the phosphor layers 126 may be provided in the form of a plurality of independent pads aligned respectively with the electron emitters 12.

As shown in FIG. 36, when electrons emitted from the electron emitters 12 impinge upon the phosphor layers 126 on the reverse side of the transparent substrate 40, the phosphor layers 126 are excited to emit phosphorescent light. At this time, part of the light, e.g., light denoted by 128a, passes through the anode electrode 124 and the transparent substrate 40. Other part of the light, e.g., light denoted by 128b, travels to the fixed substrate 82, and is totally reflected by the light reflecting film 120 and passes through the anode electrode 124 and the transparent substrate 40. Generally, since the depth by which the emitted electrons enters the phosphor layers 126 is smaller than the thickness of the phosphor layers 126, the light emission 128b from the surface of the phosphor layers 126 which is irradiated with the emitted electrons is greater in amount than the light emission 128a from the other surface of the phosphor layers 126 which is opposite to the surface irradiated with the emitted electrons because the light emission 128b is not absorbed by the phosphor layers 126. Accordingly, the light emission 128b makes the light source 10A higher in luminance and efficiency.

As the straightness of electrons emitted from the electron emitters 12 is high, if the phosphor layers 126 are patterned in alignment with the respective electron emitters 12, then the electrons emitted from the electron emitters 12 are efficiently applied to the phosphor layers 126. Since all light emission 128b reflected from the light reflecting film 120 passes through the portions of the anode electrode 124 which are free of the phosphor layers 126, the phosphorescent light emission excited by the phosphor layers 126 can effectively and efficiently be utilized as a light emission from the surface of the transparent substrate 40. Therefore, the openings provided between the phosphor layers 126 can effectively be utilized. As the light emission is also produced from the openings provided above the electron emitters 12, the electron emitters 12 do not need to be placed fully on the fixed substrate 82, but may be disposed at spaced intervals thereon for a uniform high-luminant surface light emission. As the electric power required to energize the electron emitters 12 is reduced, the light emission from the light source 10A is highly efficient. In addition, the light source 10A can be manufactured inexpensively because the number of electron emitters 12 used is relatively small.

As the straightness of electrons emitted from the electron emitters 12 is high, as described above, the phosphor layers 126 and the electron emitters 12 may be formed in identical or similar patterns, and hence the pattern of the phosphor layers 126 may be designed with ease.

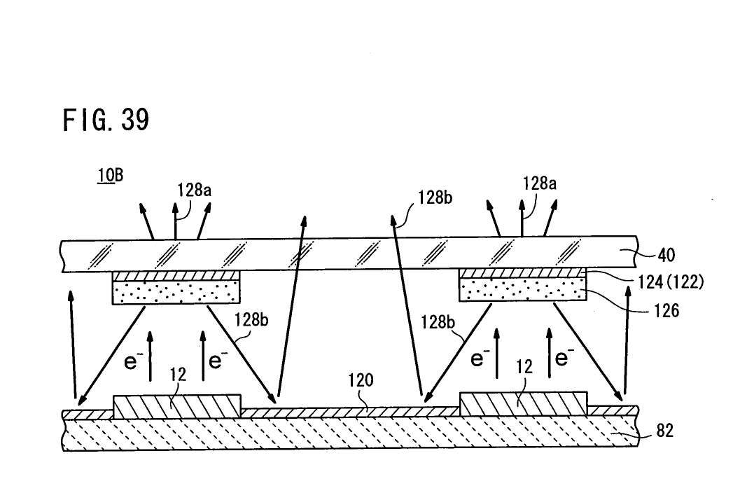

As shown in FIG. 39, a light source 10B according to a second specific example is of essentially the same structure as the light source 10A according to the first specific example described above, except that anode electrodes 124 are patterned to be present at positions aligned with the respective phosphor layers 126.

According to the first specific example described above, when the reflected light 128b passes through the portions free of the phosphor layers 126, i.e., through the openings provided between the phosphor layers 126, the reflected light 128b is attenuated to a certain degree by the anode electrode 124. According to the second specific example, however, since no anode electrode is present in the portions free of the phosphor layers 126, i.e., the openings provided between the phosphor layers 126, the reflected light 128b is guided out of the transparent substrate 40 without being significantly attenuated. Therefore, the light source 10B according to the second specific example is capable of more effectively utilizing the reflected light 128b.

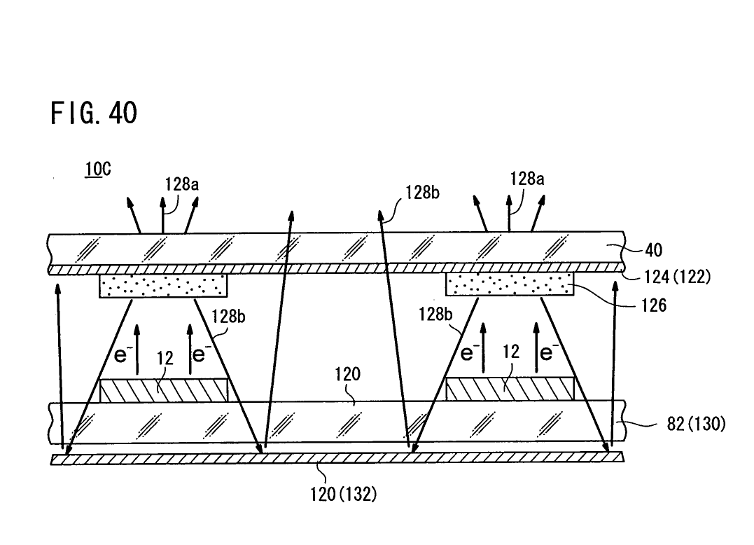

As shown in FIG. 40, a light source 10C according to a third specific example is of essentially the same structure as the light source 10A according to the first specific example described above, except that the fixed substrate 82 comprises a second transparent substrate 130 such as a glass substrate, for example, and a light reflecting film 120 is disposed behind the second transparent substrate 130, i.e., on or near the surface of the second transparent substrate 130 remote from the transparent substrate 40. The light reflecting film 120 may be replaced with a light reflecting plate 132 which may comprise a metal plate whose principal surface polished to a mirror surface finish.

The light 128b that travels to the second transparent substrate 130 passes through the second transparent substrate 130 and is then reflected by the light reflecting film 120. Then, the light 128b passes again through the second transparent substrate 130, and thereafter passes through the anode electrode 124 and the transparent substrate 40. The third specific example offers the same advantages as the first specific example. The anode electrode 124 may be patterned in the same manner as with the second specific example.

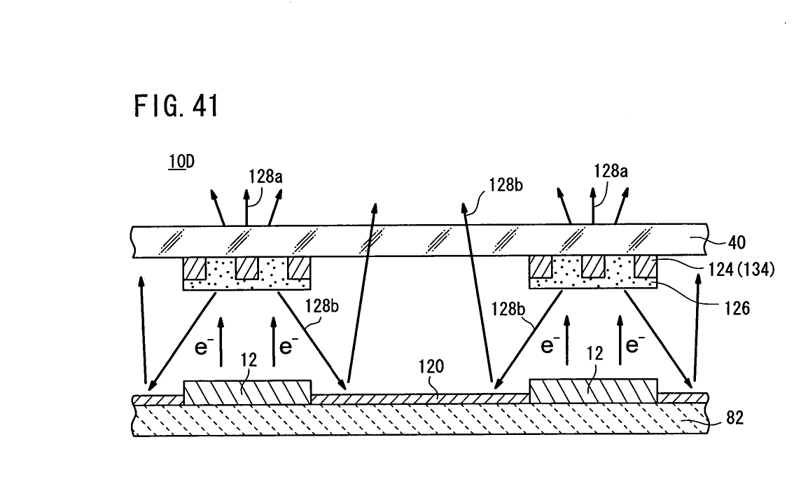

As shown in FIG. 41, a light source 10D according to a fourth specific example is of essentially the same structure as the light source 10A according to the first specific example described above, except that the anode electrode 124 comprises wire electrodes 134, rather than the transparent electrode 122, and the wire electrodes 134 are coated with phosphor layers 126. The wire electrodes 134 may be formed by printing a metal film, e.g., an aluminum film, on the reverse side of the transparent substrate 40. The phosphor layers 126 may contain electrically conductive frit.

According to the fourth specific example, the reflected light 128b is effectively utilized as with the third specific example.

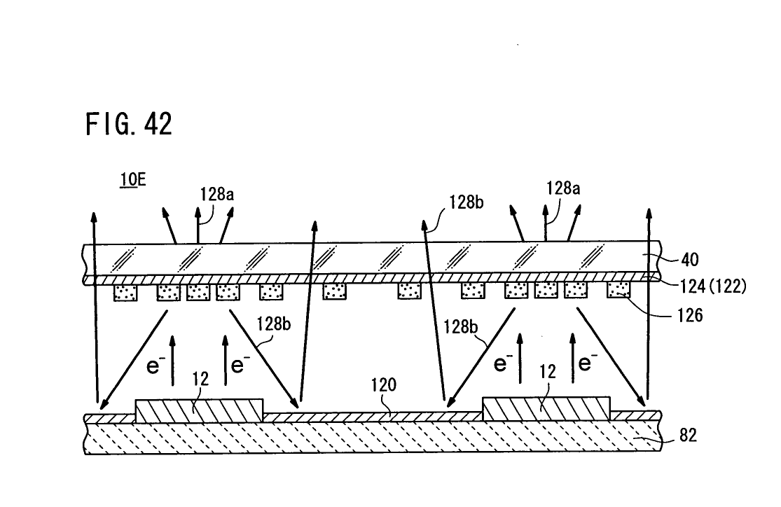

As shown in FIG. 42, a light source 10E according to a fifth specific example is of essentially the same structure as the light source 10A according to the first specific example described above, except that a number of narrow phosphor layers 126 are disposed on the anode electrode 124. The phosphor layers 126 may be spaced at equal distances or pitches, or may be spaced at smaller distances or pitches in regions aligned with the electron emitters 12 and at greater or distances pitches in regions not aligned with the electron emitters 12. The phosphor layers 126 may be in the form of stripes or lands. The fifth specific example offers the same advantages as the first specific example.

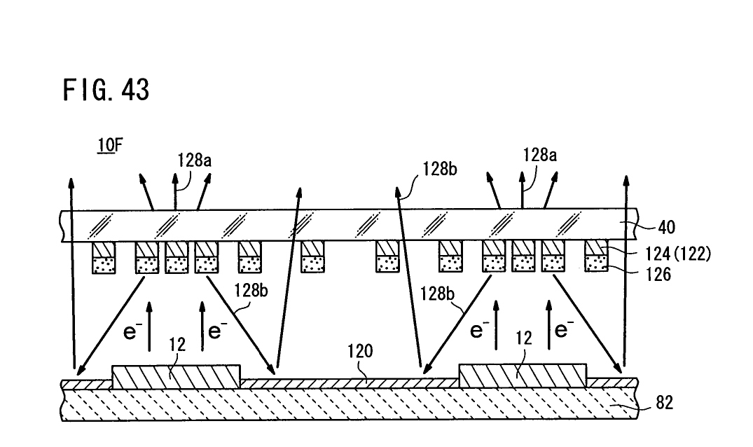

As shown in FIG. 43, a light source 10F according to a sixth specific example is of essentially the same structure as the light source 10E according to the fifth specific example described above, except that anode electrodes 124 are patterned in alignment with the phosphor layers 126. According to the sixth specific example, the reflected light 128b is effectively utilized as with the third specific example.

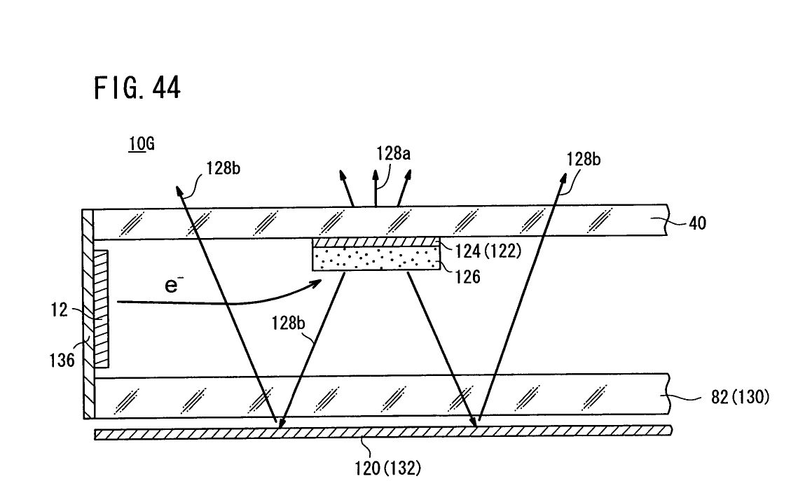

As shown in FIG. 44, a light source 10G according to a seventh specific example is of essentially the same structure as the light source 10C according to the third specific example described above, except that the light source 10G has a side plate 136 extending substantially perpendicularly to the transparent substrate 40, electron emitters 12 mounted on a surface of the side plate 136 and facing the space defined between the transparent substrate 40 and the fixed substrate 82, i.e., the second transparent substrate 130, and anode electrodes 124 patterned in alignment with the phosphor layers 126.

The side plate 136 is disposed on a side of the transparent substrate 40 and a side of the fixed substrate 82. However, the side plate 136 may be disposed on one side, two sides, three sides, or four sides of the transparent substrate 40 and the fixed substrate 82. The light reflecting film 120 may be replaced with a light reflecting plate 132 which may comprise a metal plate whose principal surface is polished to a mirror surface finish.

In the light source 10G according to the seventh specific example, when electrons emitted from the electron emitters 12 impinge upon the phosphor layers 126 on the reverse side of the transparent substrate 40, the phosphor layers 126 are excited to emit phosphorescent light. At this time, part of the light, e.g., light denoted by 128a, passes through the anode electrode 124 and the transparent substrate 40. Other part of the light, e.g., light denoted by 128b, travels to the fixed substrate 82, i.e., the second transparent substrate 130, and passes through the second transparent substrate 130. Then, the light 128b is totally reflected by the light reflecting film 120, passes again through the second transparent substrate 130, and then passes through the transparent substrate 40.

With the light source 10G according to the seventh specific example, the side plate 136 doubles as a peripheral sealing member for sealing the peripheral edges of the transparent substrate 40 and the fixed substrate 82. The light source 10G is thus made up of a relatively small number of parts and is of a relatively small size. The electron emitters 12 may be disposed on beams or spacers that keep the transparent substrate 40 and the fixed substrate 82 spaced from each other, or the electron emitters 12 may be provided as such beams or spacers.

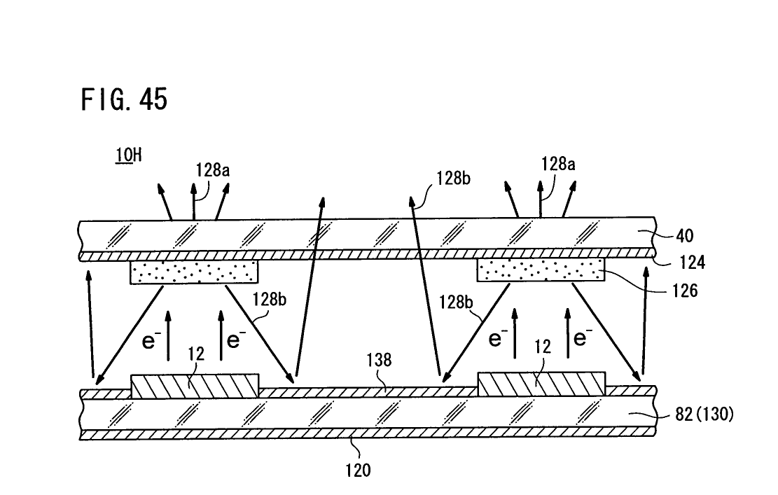

As shown in FIG. 45, a light source 10H according to an eighth specific example is of essentially the same structure as the light source 10A according to the first specific example described above, except that a white diffusion layer 138 is disposed on a portion of the principal surface of the fixed substrate 82 which is free of the electron emitters 12. According to the eighth specific example, the reflected light 128b is effectively utilized as with the first specific example.

The fixed substrate 82 may comprise a second transparent substrate 130, and a light reflecting film 120 in the form of an evaporated metal film may be disposed on the reverse side of the second transparent substrate 130 remotely from the transparent substrate 40. Light diffused by the white diffusion layer 138 is collected by the light reflecting film 120 and reflected toward the transparent substrate 40. Therefore, the reflected light 128b is more effectively utilized.

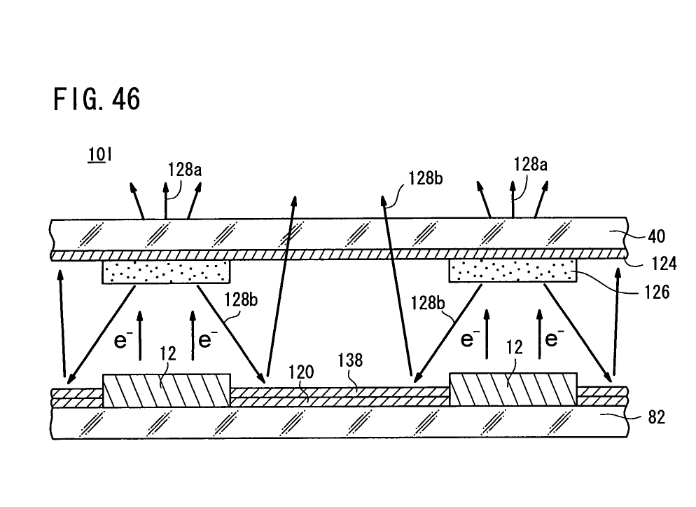

As shown in FIG. 46, a light source 10I according to a ninth specific example is of essentially the same structure as the light source 10H according to the eighth specific example described above, except that a light reflecting film 120 is disposed on a portion of the principal surface of the fixed substrate 82 which is free of the electron emitters 12, and a white diffusion layer 138 is disposed on the light reflecting film 120. According to the ninth specific example, the reflected light 128b is effectively utilized as with the eighth specific example.

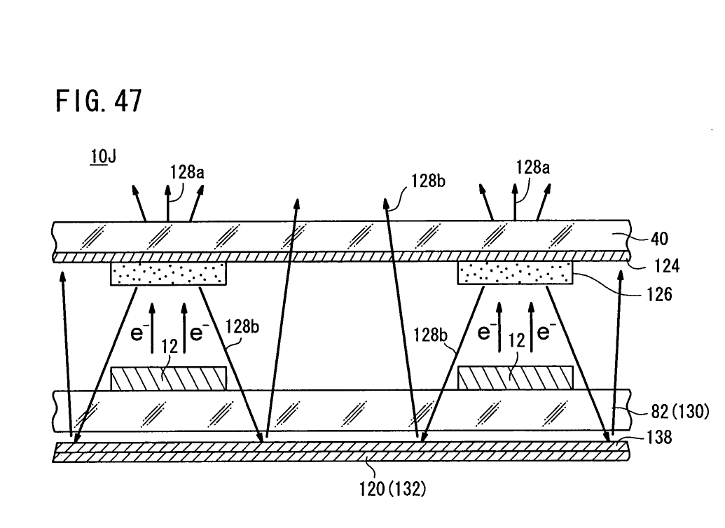

As shown in FIG. 47, a light source 10J according to a tenth specific example is of essentially the same structure as the light source 10H according to the eighth specific example described above, except that a white diffusion layer 138 and a light reflecting film 120 are disposed behind the second transparent substrate 130, i.e., on or near the surface of the second transparent substrate 130 remote from the transparent substrate 40. The light reflecting film 120 may be replaced with a light reflecting plate 132, and the white diffusion layer 138 may be disposed on the light reflecting plate 132. According to the tenth specific example, the reflected light 128b is effectively utilized as with the eighth specific example.

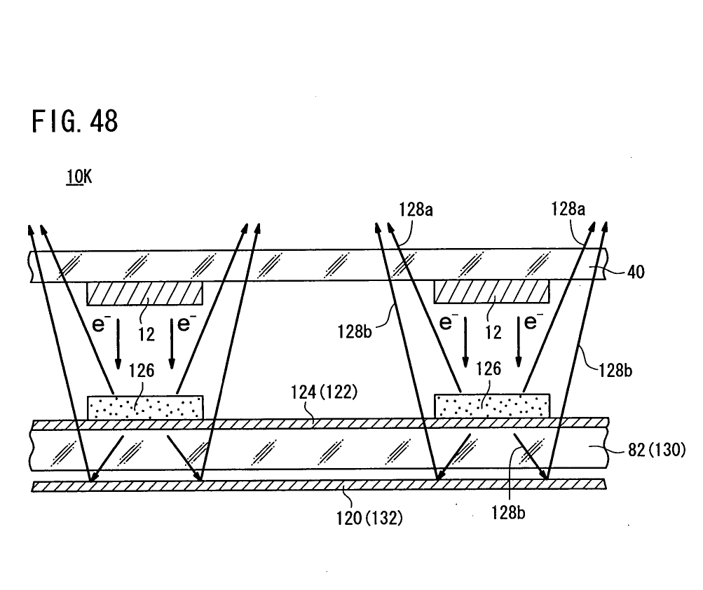

As shown in FIG. 48, a light source 10K according to an eleventh specific example has a transparent substrate 40, a fixed substrate 82, i.e., a second transparent substrate 130, disposed in facing relation to the transparent substrate 40, and a plurality of electron emitters 12 disposed on the reverse side of the transparent substrate 40 which faces the fixed substrate 82.

An anode electrode 124 in the form of a transparent electrode 122 is disposed substantially on the entire principal surface of the fixed substrate 82 which faces the transparent substrate 40, and phosphor layers 126 are disposed on the anode electrode 124 at respective positions aligned with the electron emitters 12. A light reflecting film 120 is disposed behind the second transparent substrate 130, i.e., on or near the surface of the second transparent substrate 130 remote from the transparent substrate 40. The light reflecting film 120 may be replaced with a light reflecting plate 132 which may comprise a metal plate whose principal surface polished to a mirror surface finish.

When electrons emitted from the electron emitters 12 impinge upon the phosphor layers 126 on the principal side of the fixed substrate 82, the phosphor layers 126 are excited to emit phosphorescent light. At this time, part of the light, e.g., light denoted by 128a, travels to the transparent substrate 40 and passes through the transparent substrate 40. Other part of the light, e.g., light denoted by 128b, passes through the anode electrode 124 and the second transparent substrate 130. Then, the light 128b is totally reflected by the light reflecting film 120, passes again through the second transparent substrate 130 and the anode electrode 124, and then passes through the transparent substrate 40.

Since the totally reflected light 128b from the light reflecting film 120 passes through the portion of the transparent substrate 40 which is free of the electron emitters 12, phosphorescent light excited by the phosphor layers 126 is effectively and efficiently utilized as display light from the surface of the transparent substrate 40. Therefore, the portion of the transparent substrate 40 which is free of the electron emitters 12 is effectively utilized.

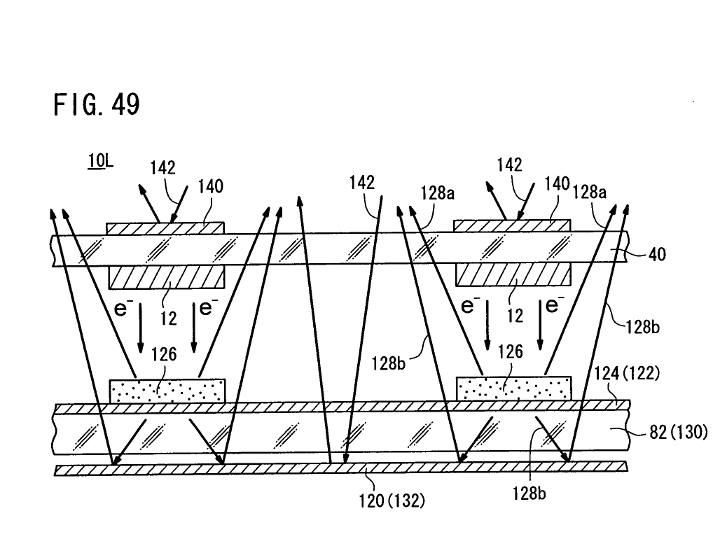

As shown in FIG. 49, a light source 10L according to a twelfth specific example is of essentially the same structure as the light source 10K according to the eleventh specific example described above, except that light diffusion sheets 140 are disposed on the surface of the transparent substrate 40 remote from the second transparent substrate 130 at respective positions aligned with the electron emitters 12.

The reflected light 128b from the light reflecting film 120 or the light reflecting plate 132 disposed behind the second transparent substrate 130 is absorbed or attenuated by the electron emitters 12 on the transparent substrate 40. However, ambient light 142 is diffused by the light diffusion sheets 140 and is utilized as a surface light emission, thus making up for the light absorbed or attenuated by the electron emitters 12 thereby to suppress a reduction in the luminance which is caused by the electron emitters 12 on the transparent substrate 40. Furthermore, since the ambient light 142 is also reflected by the light reflecting film 120 or the light reflecting plate 132, the luminance of the light source 10L is further increased. The light diffusion sheets 140 may be replaced with lenses, not shown.

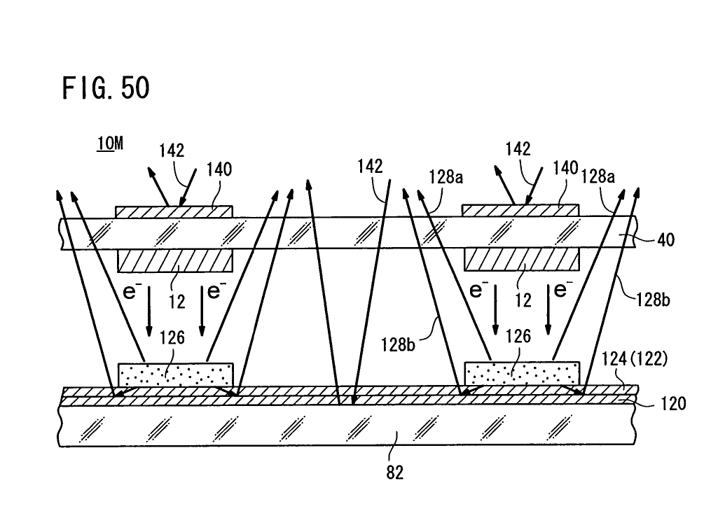

As shown in FIG. 50, a light source 10M according to a thirteenth specific example is of essentially the same structure as the light source 10L according to the twelfth specific example described above, except that the light reflecting film 120 is disposed between the fixed substrate 82 and the anode electrode 124.

Part of the light, e.g., light denoted by 128a, travels to the transparent substrate 40 and passes through the transparent substrate 40. Other part of the light, e.g., light denoted by 128b, passes through the anode electrode 124, is totally reflected by the light reflecting film 120 exactly below the anode electrode 124, passes again through the anode electrode 124, and then passes through the transparent substrate 40. According to the thirteenth specific example, the reflected light 128b and the ambient light 142 are effectively utilized as with the twelfth specific example. If the anode electrode 124 comprises a metal film having a mirror surface finish, then it can also function as a light reflecting film 120. This light reflecting film 120 may be disposed on the surface of the phosphor layers 126 remote from the surface thereof which is irradiated with electrons. Since electrons for exciting the phosphor layers 126 are note required to pass through the light reflecting film 120, unlike a metal back layer used in CRTs or the like, the voltage for accelerating electrons may be reduced, and the thickness of the light reflecting film 120 may be designed with freedom for maximizing the light reflectance.

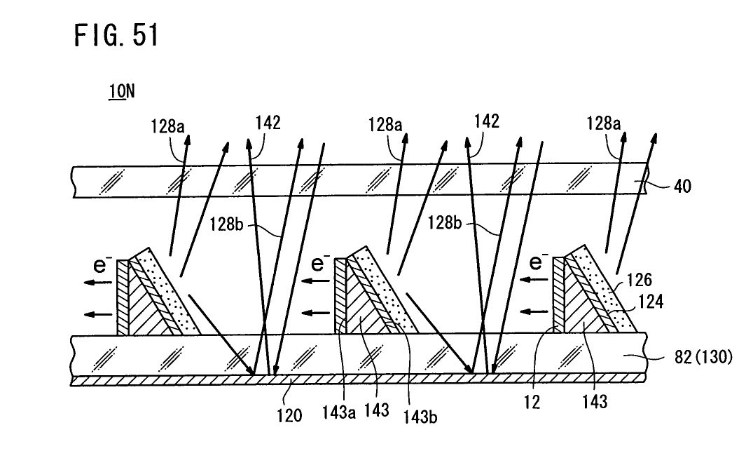

As shown in FIG. 51, a light source 10N according to a fourteenth specific example has a transparent substrate 40, a fixed substrate 82, i.e., a second transparent substrate 130, disposed in facing relation to the transparent substrate 40, and a plurality of support members 143 disposed on the principal surface of the fixed substrate 82 and supporting respective electron emitters 12 thereon.

Each of the support members 143 has a first surface 143a extending at a first predetermined angle of 900, for example, with respect to the reverse side of the transparent substrate 40 and a second surface 143b extending at a second predetermined angle of 60°, for example, with respect to the reverse side of the transparent substrate 40. The electron emitters 12 are disposed respectively on the first surfaces 143a of the support members 143, and anode electrodes 124 are disposed respectively on the second surfaces 143b thereof. Phosphor layers 126 are disposed respectively on the anode electrodes 124. The phosphor layers 126 are disposed in respective positions facing both the transparent substrate 40 and the electron emitter 12 on another support member 143.

When electrons emitted from the electron emitters 12 impinge upon the phosphor layers 126 on the second surfaces 143b of the confronting support members 143, the phosphor layers 126 are excited to emit phosphorescent light. At this time, part of the light, e.g., light denoted by 128a, passes through the transparent substrate 40. Other part of the light, e.g., light denoted by 128b, travels to the second transparent substrate 130, and is totally reflected by the light reflecting film 120 and passes through the second transparent substrate 130 and the transparent substrate 40.

Since the transparent substrate 40 is free of any films or members for absorbing or attenuating the totally reflected light 128b from the light reflecting film 120, the phosphorescent light emission from the phosphor layers 126 by excitation thereof is effectively and efficiently utilized as a light emission from the surface of the transparent substrate 40. As the transparent substrate 40 is free of any films or members for absorbing or attenuating light, the light emission from the phosphor layers 126 is efficiently extracted.

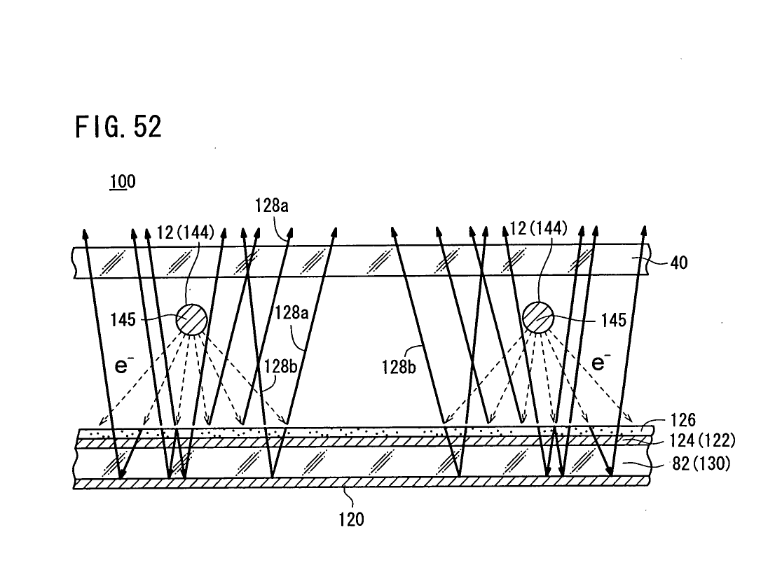

As shown in FIG. 52, a light source 100 according to a fifteenth specific example is of essentially the same structure as the light source 10K according to the eleventh specific example described above, except that conductive wires 145 having carbon nanowalls 144 on their surfaces are employed as electron emitters 12, an anode electrode 124 in the form of a transparent electrode 122 is disposed on the entire principal surface of the fixed substrate 82 in the form of a second transparent substrate 130, a phosphor layer 126 is disposed on the entire upper surface of the anode electrode 124, and a light reflecting film 120 is disposed on the reverse side of the second transparent substrate 130.

Electrons emitted from the carbon nanowalls 144 have no straightness. Therefore, the emitted electrons are spread and travel through the vacuum, and impinge upon the phosphor layer 126, which are excited to emit phosphorescent light. At this time, part of the light, e.g., light denoted by 128a, travels to the transparent substrate 40 and passes through the transparent substrate 40. Light denoted by 128b which leaves the surface of the phosphor layer 126 remote from the surface thereof which is hit by the electrons passes through the anode electrode 124 and the second transparent substrate 130, and is totally reflected by the light reflecting film 120. Then, the light 128b passes through the second transparent substrate 130 and the anode electrode 124, and then through the transparent substrate 40.

Since the totally reflected light 128b from the light reflecting film 120 passes through the transparent substrate 40 that is free of the electron emitters 12, phosphorescent light excited by the phosphor layers 126 is effectively and efficiently utilized as display light from the surface of the transparent substrate 40.

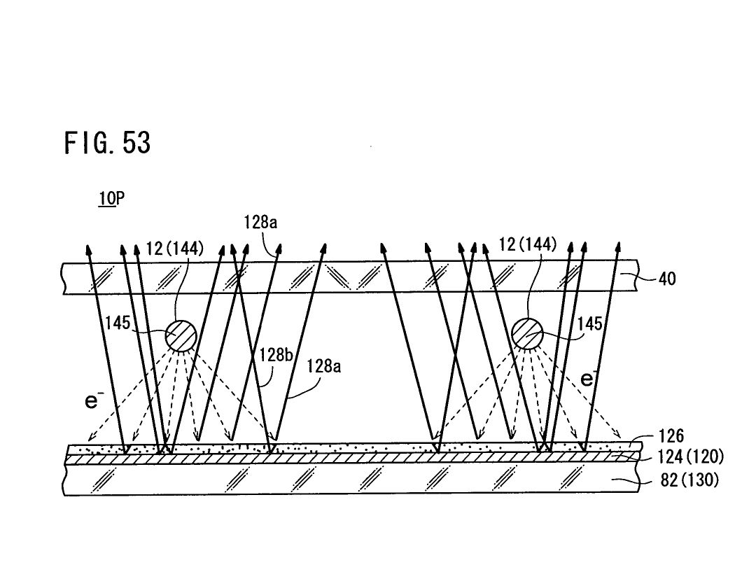

As shown in FIG. 53, a light source 10P according to a sixteenth specific example is of essentially the same structure as the light source 100 according to the fifteenth specific example described above, except that an anode electrode 124 in the form of a metal film is disposed between the phosphor layer 126 and the fixed substrate 82. The anode electrode 124 functions as, i.e., doubles as, a light reflecting film 120.

Part of the phosphorescent light, e.g., light denoted by 128a, travels to the transparent substrate 40 and passes through the transparent substrate 40. Light denoted by 128b which leaves the surface of the phosphor layer 126 remote from the surface thereof which is hit by the electrons is totally reflected by the anode electrode 124, doubling as the light reflecting film 120, disposed directly beneath the phosphor layer 126, and passes through the transparent substrate 40. According to the sixteenth specific example, the reflected light 128b is effectively utilized as with the fifteenth specific example. Particularly, as the light reflecting film 120 does not need to be independently provided, the light source 10P can be manufactured relatively inexpensively.

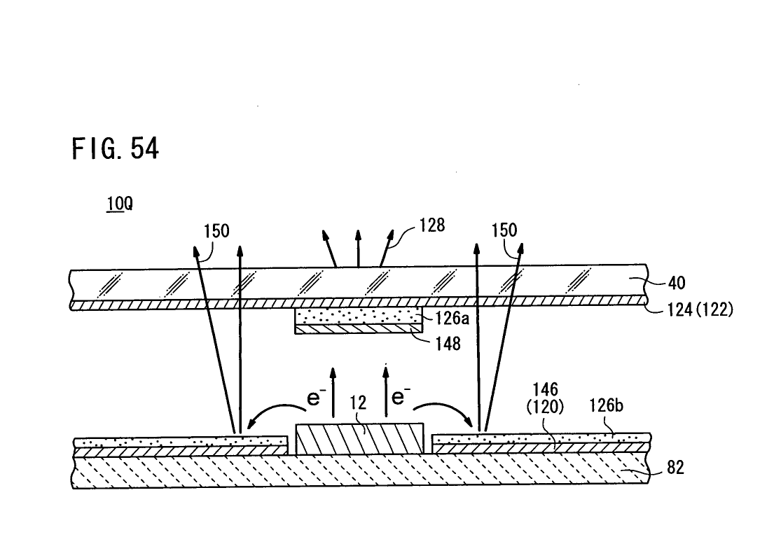

As shown in FIG. 54, a light source 10Q according to a seventeenth specific example has a transparent substrate 40, a fixed substrate 82 disposed in facing relation to the transparent substrate 40, one or more electron emitters 12 disposed on the fixed substrate 82, an anode electrode 124 in the form of a transparent electrode 122 disposed on the reverse side of the transparent substrate 40 which faces the fixed substrate 82, a first phosphor layer 126a disposed on the anode electrode 124, an auxiliary electrode 146 disposed on the portion of the fixed substrate 82 which is free of the electron emitters 12, and a second phosphor layer 126b disposed on the auxiliary electrode 146.

The first phosphor layer 126a is disposed on the anode electrode 124 at a position aligned with the electron emitter 12. A metal back layer 148 is disposed on an end face of the first phosphor layer 126a. The second phosphor layer 126b is disposed on the entire upper surface of the auxiliary electrode 146.

Electrons emitted from the electron emitter 12 on the fixed substrate 82 are accelerated by the anode electrode 124 on the transparent substrate 40, and impinge upon the first phosphor layer 126a on the transparent substrate 40, whereupon the first phosphor layer 126a is excited to emit phosphorescent light 128. Almost 100% of the phosphorescent light 128 is emitted as a surface emission from the transparent substrate 40 in the presence of the metal back layer 148. Electrons emitted from the electron emitter 12 on the fixed substrate 82 are also accelerated by the auxiliary electrode 146 on the fixed substrate 82, and impinge upon the second phosphor layer 126b on the fixed substrate 82, whereupon the second phosphor layer 126b is excited to emit phosphorescent light 150. The phosphorescent light 150 is also emitted as a surface emission from the transparent substrate 40.

Therefore, the surface emission as the phosphorescent light 128 from the first phosphor layer 126a on the transparent substrate 40 and the surface emission as the phosphorescent light 150 from the second phosphor layer 126b on the fixed substrate 82 are combined with each other and emitted from the light source 10Q. Accordingly, the utilization ratio of the emitted phosphorescent light is increased for a high-luminance light emission.

Specifically, a voltage is applied to the auxiliary electrode 146 in addition to the anode electrode 124 to spread the electrons emitted from the electron emitters 12 to prevent the electrons from concentrating. Thus, the first phosphor layer 126a can emit uniform light with increased efficiency.

For example, it is preferable to diffuse the electrons to a level of 10 μA/cm² for thereby preventing the efficiency of the phosphor layer from being lowered due to a saturation thereof caused by an excessive amount of electrons.

The electrons accelerated toward the auxiliary electrode 146 also impinge upon the second phosphor layer 126b on the auxiliary electrode 146, causing the second phosphor layer 126b to emit light. Therefore, the second phosphor layer 126b is also effectively utilized. In this case, as the metal back layer 148 is not required, the voltage applied to the auxiliary electrode 146 may be lower than the electron acceleration voltage applied to the anode electrode 124. Since the light from the second phosphor layer 126b is emitted from the surface irradiated with the electrons, the light is bright. Because the light from the second phosphor layer 126b is emitted from the transparent substrate 40 through the portion thereof which is free of the first phosphor layer 126a, the emitted light is free of a loss which would otherwise result from the impingement upon the first phosphor layer 126a.

The voltage applied to the auxiliary electrode 146 is effective to control the spreading of electrons emitted from the electron emitters 12. Consequently, the spreading of such electrons can be optimized. The surface of the auxiliary electrode 146 may be processed into a mirror surface finish to allow the auxiliary electrode 146 to serve as a light reflecting film 120.

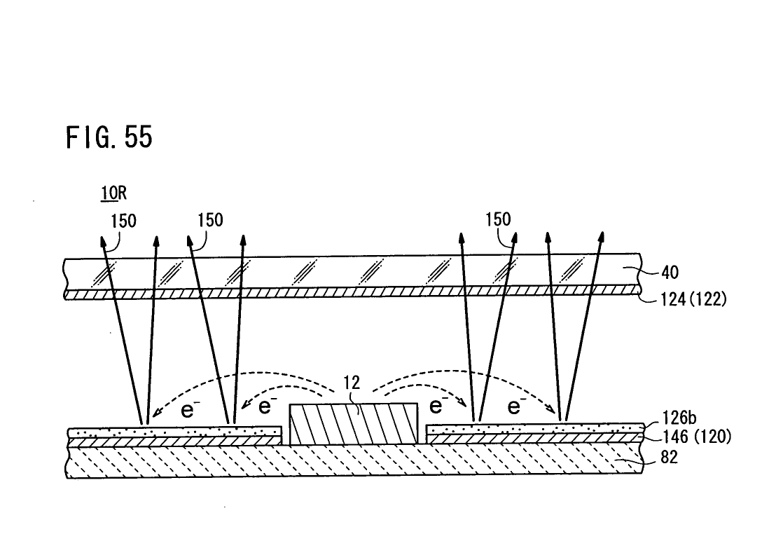

As shown in FIG. 55, a light source 10R according to an eighteenth specific example is devoid of the first phosphor layer 126a and the metal back layer 148 (see FIG. 54) which are disposed exactly above the electron emitter 12. As the transparent substrate 40 is free of any films or members for absorbing light, the light emission from the second phosphor layer 126b can be extracted efficiently. The transparent electrode 122 may also be dispensed with for preventing the emitted light from being attenuated.

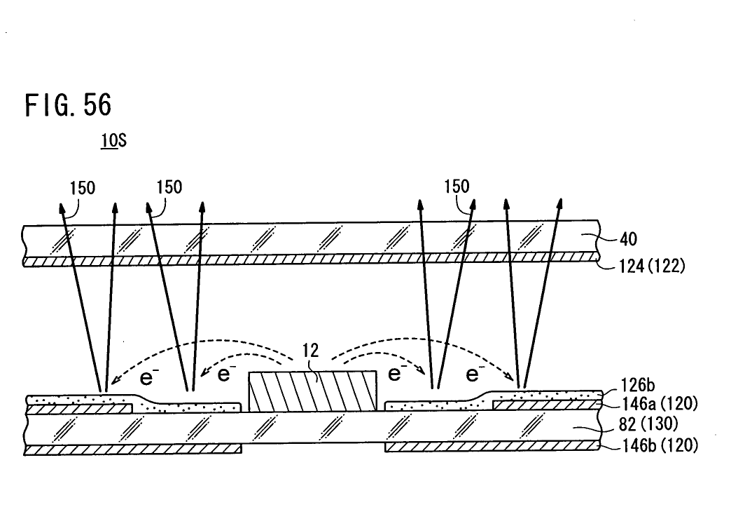

FIG. 56 shows a light source 10S according to a nineteenth specific example which is a modification of the light source 10R shown in FIG. 55. The light source 10S includes an auxiliary electrode 146b disposed on the surface of the fixed substrate 82 which is opposite to the surface thereof facing the transparent substrate 40, in addition to the auxiliary electrode 146a disposed on the surface of the fixed substrate 82 which faces the transparent substrate 40. The auxiliary electrode 146b allows a sufficient insulating distance to be kept between the auxiliary electrode 146a and the drive electrode of the electron emitter 12 and also between their interconnects, and also allows the auxiliary electrode 146a to be designed with increased freedom for generating an electric field for dispersing the emitted electrons. An insulating substrate of glass or the like may be disposed between the electron emitter 12 and the fixed substrate 82 for maintaining the above insulating distance.

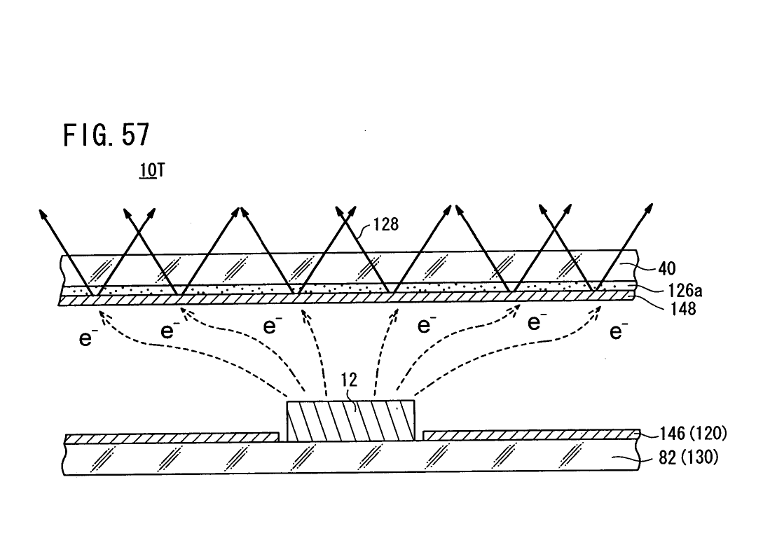

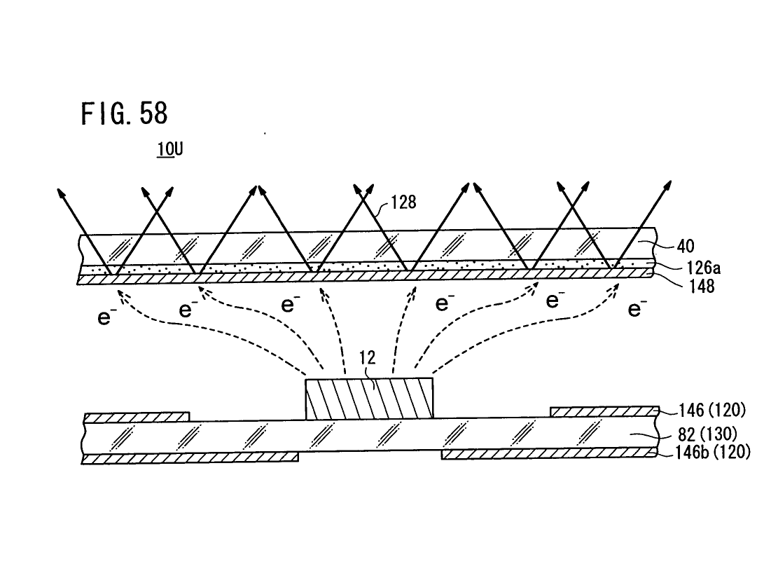

In the light sources 10Q, 10R, 10S according to the seventeenth, eighteenth, and nineteenth specific examples, the emitted electrons are spread by the auxiliary electrode 146 for exciting the second phosphor layer 126b on the fixed substrate 82. However, a light source 10T according a twentieth specific example shown in FIG. 57 and a light source 10U according a twenty-first specific example shown in FIG. 58 have an auxiliary electrode 146 for generating an electric field to spread the emitted electrons to excite the first phosphor layer 126a on the transparent substrate 40. The first phosphor layer 126a is prevented from being saturated by an excessive amount of electrons impinging thereupon, and is capable of emitting phosphorescent light highly efficiently for a spread uniform surface emission.

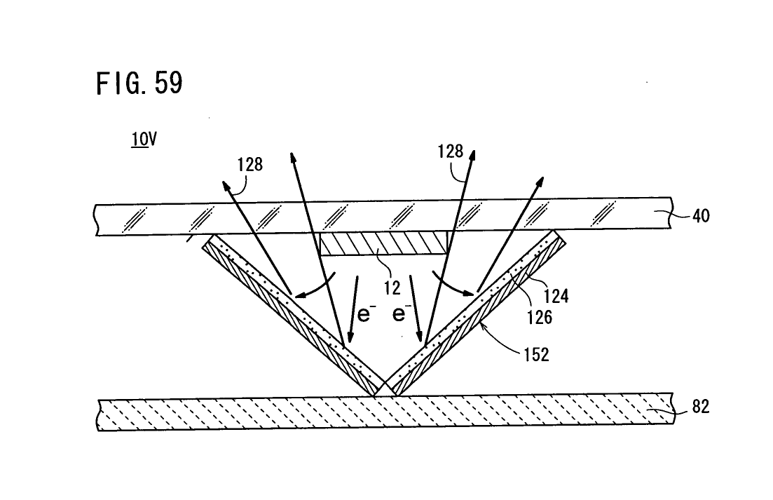

As shown in FIG. 59, a light source 10V according to a twenty-second specific example has a transparent substrate 40, a fixed substrate 82 disposed in facing relation to the transparent substrate 40, one or more electron emitters 12 disposed on the reverse side of the transparent substrate 40 which faces the fixed substrate 82, and a laminated assembly 152 disposed between the transparent substrate 40 and the fixed substrate 82. The laminated assembly 152 comprises an anode electrode 124 and a phosphor layer 126.

The laminated assembly 152 is oriented such that the phosphor layer 126 faces the transparent substrate 40. The laminated assembly 152 has a bent portion in alignment with the electron emitter 12, and has opposite ends fixed to the transparent substrate 40.

Electrons emitted from the electron emitter 12 on the transparent substrate 40 are accelerated by the anode electrode 124 of the laminated assembly 152, and impinge upon the phosphor layer 126 of the laminated assembly 152, whereupon the phosphor layer 126 is excited to emit phosphorescent light 128. The phosphorescent light 128 is emitted as a surface emission. The utilization ratio of the emitted phosphorescent light 128 is increased for a high-luminance light emission. The laminated assembly 152 thus shaped is able to generate an electric field for closely controlling the trajectory of the emitted electrons.

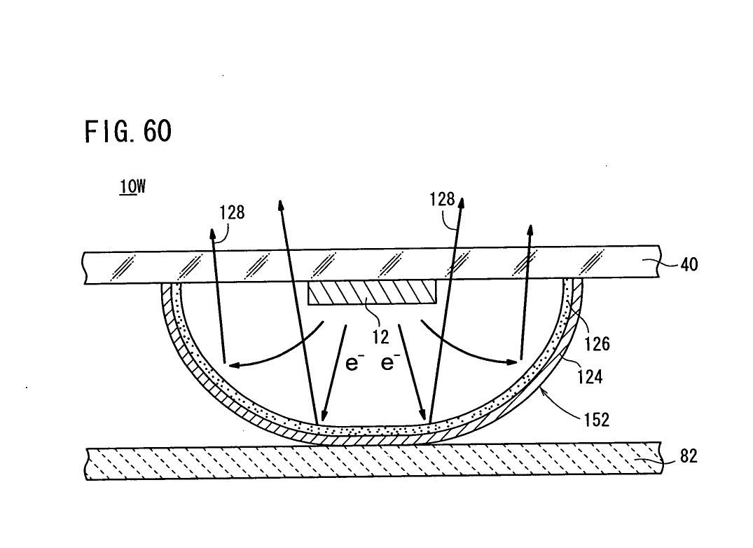

As shown in FIG. 60, a light source 10W according to a twenty-third specific example is of essentially the same structure as the light source 10V according to the twenty-second specific example described above, except that the laminated assembly 152 has a curved portion confronting the electron emitter 12. According to the twenty-third specific example, the utilization ratio of the emitted phosphorescent light 128 is also increased for a high-luminance light emission. The laminated assembly 152 thus shaped is able to generate an electric field for closely controlling the trajectory of the emitted electrons.

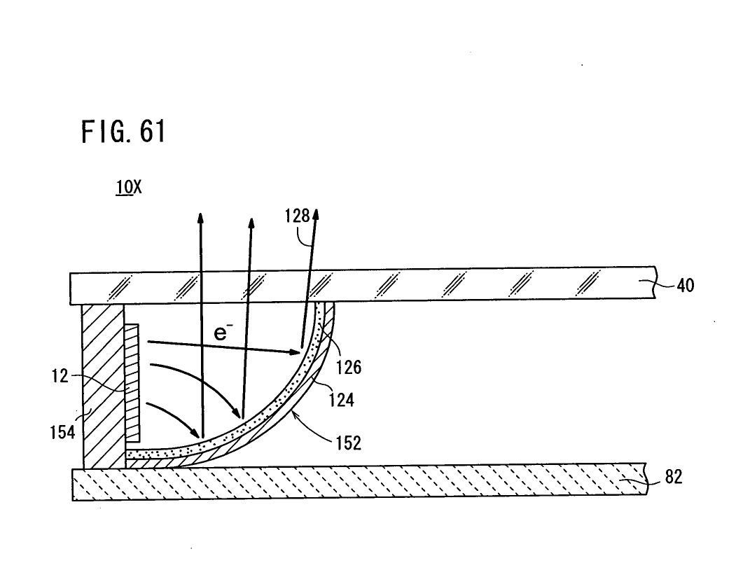

As shown in FIG. 61, a light source 10X according to a twenty-fourth specific example is of essentially the same structure as the light source 10W according to the twenty-third specific example described above, except that the light source 10X has a side plate 154 extending substantially perpendicularly to the transparent substrate 40, and electron emitters 12 mounted on a surface of the side plate 154 and facing the space defined between the transparent substrate 40 and the fixed substrate 82, and the laminated assembly 152 has an end fixed to the transparent substrate 40 and the other end to the side plate 154. According to the twenty-fourth specific example, the laminated assembly 152 is able to generate an electric field for closely controlling the trajectory of the emitted electrons, and the utilization ratio of the emitted phosphorescent light 128 is also increased for a high-luminance light emission. As the transparent substrate 40 is free of any films or members for absorbing or attenuating light, the light emission is efficiently extracted. Furthermore, the side plate 154 functions as a spacer for keeping a sealed vacuum space.

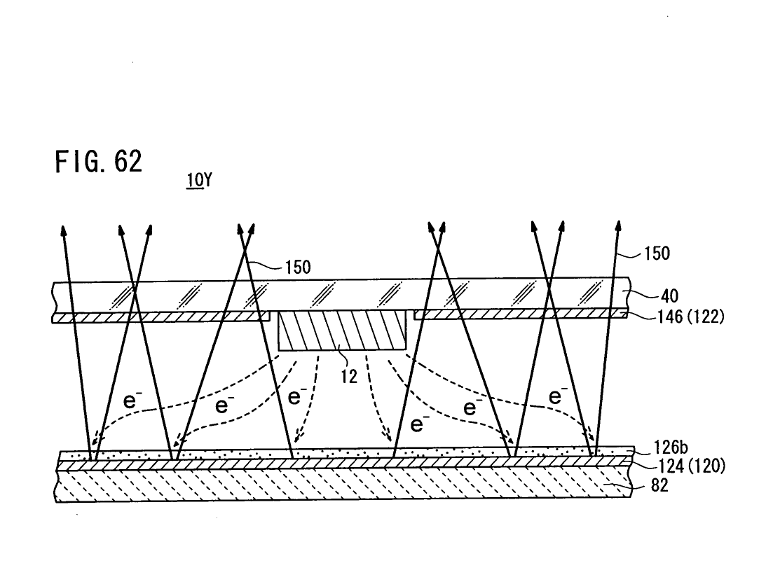

In a light source 10Y according to a twenty-fifth specific example shown in FIG. 62 and a light source 10Z according to a twenty-sixth specific example shown in FIG. 63, electrons emitted from the electron emitter 12 disposed on the transparent substrate 40 are spread by an electric field that is generated by the auxiliary electrode 146 in the form of the transparent electrode 122 that is disposed on the transparent substrate 40. The light sources 10Y, 10Z are devoid of the laminated assembly 152 of the light source 10V (see FIG. 59) according to the twenty-second specific example and the light source 10W (see FIG. 60) according to the twenty-third specific example. In the light sources 10Y, 10Z, the phosphor layer is prevented from being saturated, and is capable of emitting phosphorescent light highly efficiently from its irradiated surface for a spread uniform surface emission.

In the light sources 10A through 10Z according to the above specific examples, voltages required to generate electric fields for accelerating electrons and controlling the trajectory of electrons (including the spreading of emitted electrons) are applied to the anode electrode 124 and the auxiliary electrode 146.

Although certain preferred embodiments of the present invention have been shown and described in detail, it should be understood that various changes and modifications may be made therein without departing from the scope of the appended claims.

What is claimed is:

1. A light source comprising:
at least one electron emitter;
a transparent substrate for guiding therethrough a phosphorescent light emission based on electrons emitted from said electron emitter; and
light reflecting means disposed in facing relation to said transparent substrate, for reflecting said phosphorescent light emission to said transparent substrate.

2. A light source according to claim 1, further comprising:
an anode electrode comprising a transparent electrode; and
a phosphor layer;
said anode electrode and said phosphor layer being disposed on a surface of said transparent substrate, the surface facing said light reflecting means.

3. A light source according to claim 2, wherein at least said phosphor layer is disposed partly on said transparent substrate and provides an opening through which said transparent electrode is partly exposed.

4. A light source according to claim 2, wherein said anode electrode and said phosphor layer are disposed partly on said transparent substrate and provide an opening through which said transparent substrate is partly exposed.

5. A light source according to claim 1, wherein said electron emitter is disposed on a surface facing said transparent substrate and extending substantially parallel to a surface of said transparent substrate.

6. A light source according to claim 5, further comprising:
a fixed substrate disposed in facing relation to said transparent substrate, said electron emitter being disposed on said fixed substrate.

7. A light source according to claim 1, wherein said electron emitter is disposed on a surface extending not parallel to a surface of said transparent substrate.

8. A light source according to claim 7, further comprising:
a fixed substrate disposed in facing relation to said transparent substrate; and
a side plate having said surface which extends substantially perpendicularly to at least said transparent substrate;
said electron emitter being disposed on said surface of the side plate and facing a space defined between said transparent substrate and said fixed substrate.

9. A light source according to claim 1, wherein said electron emitter is disposed on a surface facing said transparent substrate and extending substantially parallel to a surface of said transparent substrate, further comprising:
a fixed substrate disposed in facing relation to said transparent substrate, said electron emitter being disposed on said fixed substrate;
said light reflecting means comprising a light reflecting layer and/or a white diffusion layer disposed on a portion of said fixed substrate, the portion being free of said electron emitter.

10. A light source according to claim 1, wherein said electron emitter is disposed on a surface facing said transparent substrate and extending substantially parallel to a surface of said transparent substrate, further comprising:
a fixed substrate disposed in facing relation to said transparent substrate, said electron emitter being disposed on said fixed substrate;
said fixed substrate comprising a second transparent substrate;
said light reflecting means comprising a light reflecting layer and/or a white diffusion layer disposed on a surface of said second transparent substrate remote from said transparent substrate.

11. A light source according to claim 1, further comprising:
a fixed substrate disposed in facing relation to said transparent substrate; and
an anode electrode and a phosphor layer which are disposed on a surface of said fixed substrate, the surface facing said transparent electrode.

12. A light source according to claim 11, wherein said electron emitter is disposed on a surface of said transparent substrate, the surface facing said fixed substrate.

13. A light source according to claim 12, further comprising:
a light diffusion member disposed on a surface of said transparent substrate remote from said fixed substrate, at a position aligned with said electron emitter.

14. A light source according to claim 11, wherein said anode electrode comprises a transparent electrode;
said light reflecting means comprising a light reflecting layer and/or a white diffusion layer disposed between said fixed substrate and said anode electrode.

15. A light source according to claim 11, wherein said anode electrode doubles as said light reflecting means.

16. A light source according to claim 11, wherein said fixed substrate comprises a second transparent substrate;
said light reflecting means comprising a light reflecting layer and/or a white diffusion layer disposed on a surface of said second transparent substrate remote from said transparent substrate.

17. A light source according to claim 1, wherein said electron emitter is disposed on a first surface extending at a first predetermined angle with respect to a surface of said transparent substrate, and said anode electrode is disposed on a second surface extending at a second predetermined angle with respect to the surface of said transparent substrate, said light source further comprising
a phosphor layer disposed on said anode electrode in a position facing both said transparent substrate and said electron emitter.

18. A light source according to claim 17, further comprising:
a fixed substrate disposed in facing relation to said transparent substrate; and
a support member disposed on said fixed substrate and providing said first surface and said second surface.

19. A light source according to claim 18, wherein said fixed substrate comprises a second transparent substrate;
said light reflecting means comprising a light reflecting layer and/or a white diffusion layer disposed on a surface of said second transparent substrate remote from said transparent substrate.

20. A light source comprising:
a transparent substrate;
a fixed substrate disposed in facing relation to said transparent substrate;
at least one electron emitter disposed on said fixed substrate;
an anode electrode comprising a transparent electrode;
a first phosphor layer, said anode electrode and said first phosphor layer being disposed on a surface of said transparent substrate which faces said fixed substrate; and
an auxiliary electrode and a second phosphor layer which are disposed on a portion of said fixed substrate, the portion being free of said electron emitter.

21. A light source according to claim 20, wherein said auxiliary electrode functions as light reflecting means for reflecting light emitted from said second phosphor layer to said transparent substrate.

22. A light source according to claim 20, wherein at least said first phosphor layer is disposed partly on said transparent substrate and provides an opening through which said anode electrode is partly exposed.

23. A light source according to claim 20, wherein said anode electrode and said first phosphor layer are disposed partly on said transparent substrate and provide an opening through which said transparent substrate is partly exposed.

24. A light source comprising:
at least one electron emitter;
a transparent substrate for guiding therethrough a phosphorescent light emission based on electrons emitted from said electron emitter; and
a laminated assembly disposed in facing relation to said transparent substrate, said laminated assembly comprising an anode electrode and a phosphor layer;
said laminated assembly being oriented such that said phosphor layer confronts said transparent substrate.

25. A light source according to claim 24, wherein said electron emitter is disposed on a surface of said transparent substrate, the surface facing said laminated assembly;
said laminated assembly having a bent portion in alignment with said electron emitter and ends fixed to said transparent substrate.

26. A light source according to claim 24, wherein said electron emitter is disposed on a surface not parallel to a surface of said transparent substrate;
said laminated assembly having a bent portion in alignment with said electron emitter and at least one end fixed to said transparent substrate.

27. A light source according to claim 26, further comprising:
a side plate having a surface which extends substantially perpendicularly to said transparent substrate;
said electron emitter being disposed on a portion of said surface of the side plate, the portion facing said transparent substrate;
said laminated assembly having an end fixed to said transparent substrate and other end fixed to said side plate.
